(19) United States
(12) Patent Application Publication
(10) Pub. No.: US 2020/0381203 A1
(43) Pub. Date: Dec. 3, 2020

(54) ELECTROMAGNETIC RELAY, ELECTRIC APPARATUS, AND ELECTRIC APPARATUS CASE

(71) Applicant: Panasonic Intellectual Property Management Co., Ltd., Osaka (JP)

(72) Inventors: Seiya SAKAGUCHI, Hokkaido (JP); Shinya KIMOTO, Osaka (JP); Ryosuke OZAKI, Osaka (JP); Kazuhiro KODAMA, Hokkaido (JP)

(73) Assignee: Panasonic Intellectual Property Management Co., Ltd., Osaka (JP)

(21) Appl. No.: 16/766,481

(22) PCT Filed: Nov. 21, 2018
(86) PCT No.: PCT/JP2018/043067

§ 371 Date: May 22, 2020

(30) Foreign Application Priority Data
Nov. 27, 2017 (JP) 2017-227282
Nov. 27, 2017 (JP) 2017-227283

(51) Int. Cl. H01H 50/42; H01H 50/14; H01H 50/04

(52) U.S. Cl. CPC H01H 50/42; H01H 50/546; H01H 50/048; H01H 50/14

(57) ABSTRACT

The contact device switches between a closed state where a movable contact is in contact with the fixed contact and an open state where the movable contact is apart from the fixed contact as the movable element moves. The bus bar is electrically connected to the fixed contact. A magnetic field generated by a current flowing through the bus bar when the contact device is in the closed state applies, to the movable element, force oriented such that the movable element is maintained at a location where the contact device is in the closed state. In such a positional relationship, the bus bar and the electromagnetic device are disposed.

### TECHNICAL FIELD

The present disclosure generally relates to electromagnetic relays, electric apparatuses, and electric apparatus cases and, more specifically, to an electromagnetic relay configured to switch between contact and separation of a movable contact with respect to a fixed contact, an electric apparatus, and an electric apparatus case.

### BACKGROUND ART

Patent Literature 1 discloses an electromagnetic relay for turning on and off a current at a contact point.

In the electromagnetic relay described in Patent Literature 1, electromagnetic force generated by energizing an excitation coil (winding wire for excitation) of an electromagnetic device moves a movable contactor included in the electromagnetic relay to bring the movable contact of the movable contactor into contact with a fixed contact of a fixed terminal included in the electromagnetic relay. This connects the fixed terminal to the movable contactor.

That is, in the electromagnetic relay described above, for example, when the excitation coil is de-energized, a contact device (the fixed contact and the movable contact) is in an open state, and electromagnetic force generated by the electromagnetic device attracts a movable element to a stator, thereby bringing the contact device into a closed state.

### CITATION LIST

### Patent Literature

Patent Literature 1: JP 2014-232668 A

### SUMMARY OF INVENTION

It is an object of the present disclosure to provide an electromagnetic relay configured to improve force for maintaining a movable element at a location where a contact device is in a closed state, an electric apparatus, and an electric apparatus case.

An electromagnetic relay according to one aspect of the present disclosure includes an electromagnetic device, a contact device, and a bus bar. The electromagnetic device includes an excitation coil, a stator, and a movable element. The electromagnetic device is configured to: attract the movable element to the stator by a magnetic field generated at the excitation coil when the excitation coil is energized; and move the movable element from a non-excitation location to an excitation location. The contact device includes a fixed contact and a movable contact. The contact device is configured to switch between a closed state where the movable contact is in contact with the fixed contact and an open state where the movable contact is apart from the fixed contact as the movable element moves. The bus bar is electrically connected to the fixed contact. The bus bar and the electromagnetic device are disposed in such a positional relationship that the magnetic field generated by a current flowing through the bus bar when the contact device is in the closed state applies, to the movable element, force oriented such that the movable element is maintained at a location where the contact device is in the closed state.

An electromagnetic relay according to another aspect of the present disclosure includes an electromagnetic device, a fixed terminal, a movable contactor, and a bus bar. The electromagnetic device includes an excitation coil, a stator, a movable element, and a yoke. The yoke forms part of a path of a magnetic flux generated at the excitation coil. The electromagnetic device is configured to: attract the movable element to the stator by a magnetic field generated at the excitation coil when the excitation coil is energized; and move the movable element from a non-excitation location to an excitation location. The fixed terminal includes a fixed contact. The movable contactor includes a movable contact. The bus bar is electrically connected to the fixed contact. The yoke includes a yoke upper board located on a same side as the movable contactor with respect to the excitation coil. At least part of the bus bar is disposed at a location where the at least part of the bus bar overlaps the yoke upper board or at a location on an opposite side of the yoke upper board from the movable contactor when viewed in a direction orthogonal to an axial direction of the excitation coil. The bus bar includes an electrical path segment. The electrical path segment extends along a tangent line direction of part of the excitation coil in a circumferential direction of the excitation coil when viewed from one side in the axial direction of the excitation coil. An orientation of a current flowing through the electrical path segment is a same as an orientation of a current flowing through the part of the excitation coil in the circumferential direction of the excitation coil when the excitation coil is energized.

An electrical apparatus according to one aspect of the present disclosure includes an electromagnetic relay, a housing that holds the electromagnetic relay, and a conductive bar that is held by the housing. The electromagnetic relay includes an electromagnetic device and a contact device. The electromagnetic device includes an excitation coil, a stator, and a movable element and is configured to: attract the movable element to the stator by a magnetic field generated at the excitation coil when the excitation coil is energized; and move the movable element from a non-excitation location to an excitation location. The contact device includes a fixed contact and a movable contact and is configured to switch between a closed state where the movable contact is in contact with the fixed contact and an open state where the movable contact is apart from the fixed contact as the movable element moves. The magnetic field generated by a current flowing through the conductive bar when the contact device is in the closed state applies, to the movable element, force oriented such that the movable element is maintained at a location where the contact device is in the closed state. In such a positional relationship, the conductive bar and the electromagnetic device are disposed.

### BRIEF DESCRIPTION OF DRAWINGS

FIG. 1A is perspective view illustrating an electromagnetic relay according to a first embodiment, and FIG. 1B is a sectional view illustrating the electromagnetic relay taken along line X1-X1;

FIG. 2 is a sectional view illustrating the electromagnetic relay taken along line X2-X2;

FIG. 3 is a diagram illustrating a flow of a current in a contact device included in the electromagnetic relay;

FIG. 4A is a diagram illustrating a positional relationship between a bus bar and a movable contactor included in the contact device and repulsive force generated between the bus bar and the movable contactor, and FIG. 4B is a diagram illustrating that a first yoke and a second yoke included in the contact device attract each other;

FIG. 5 is a diagram illustrating a positional relationship between the first yoke and the movable contactor;

FIG. 6 is a diagram illustrating that an arc generated by the contact device is extended;

FIGS. 7A and 7B are diagrams illustrating a length of an electrical path segment constituting the bus bar;

FIG. 8 is a view illustrating Lorentz force generated due to a relationship between a magnetic flux generated by a current flowing through a fixed terminal included in the contact device and a current flowing through the movable contactor and Lorentz force generated due to a relationship between a magnetic flux generated by a current flowing through an electrical path facing the fixed terminal and the current flowing through the movable contactor;

FIG. 9A corresponds to a sectional view of FIG. 2 and is a diagram illustrating assist force according to the bus bar included in the contact device, and FIG. 9B is a plan view schematically illustrating a configuration of the contact device;

FIG. 10A is a perspective view illustrating an electric apparatus according to the first embodiment, and FIG. 10B is an exploded perspective view illustrating the electric apparatus;

FIG. 11 is a perspective view illustrating a main part of the electric apparatus;

FIG. 12 is an exploded perspective view illustrating a main part of an electric apparatus according to a first variation of the first embodiment;

FIG. 13 is a perspective view illustrating the main part of the electric apparatus of the first variation;

FIG. 14 is a diagram illustrating a shape of a bus bar according to a second variation of the first embodiment;

FIG. 15 is a diagram illustrating a shape of a bus bar according to a third variation of the first embodiment;

FIG. 16 is a diagram illustrating a shape of a bus bar according to a fourth variation of the first embodiment;

FIGS. 17A and 17B are diagrams illustrating a first yoke according to a fifth variation of the first embodiment;

FIG. 18 is a diagram illustrating a contact device according to a sixth variation of the first embodiment;

FIGS. 19A and 19B are perspective views illustrating an electromagnetic relay according to a seventh variation of the first embodiment;

FIG. 20 is a diagram schematically illustrating a contact device according to an eighth variation of the first embodiment;

FIG. 21A is a perspective view illustrating one aspect of an electromagnetic relay according to the eighth variation of the first embodiment, and FIG. 21B is a bottom view of the electromagnetic relay of the eighth variation;

FIG. 22A is a perspective view illustrating another aspect of an electromagnetic relay according to the eighth variation of the first embodiment, and FIG. 22B is a bottom view of the electromagnetic relay of the eighth variation; and

FIG. 23A is perspective view illustrating an electromagnetic relay according to a second embodiment, and FIG. 23B is a sectional view illustrating the electromagnetic relay taken along line X2-X2.

### DESCRIPTION OF EMBODIMENTS

Embodiments and variations described below are mere examples of the present disclosure. The present disclosure is not limited to the embodiments and the variations. Various modifications may be made to embodiments other than the embodiments and the variations depending on design and the like within the scope of the technical idea of the present disclosure. Moreover, figures described in the following embodiments and variations are schematic views, and therefore, the ratio of sizes and the ratio of thicknesses of components in the drawings do not necessarily reflect actual dimensional ratios.

### First Embodiment

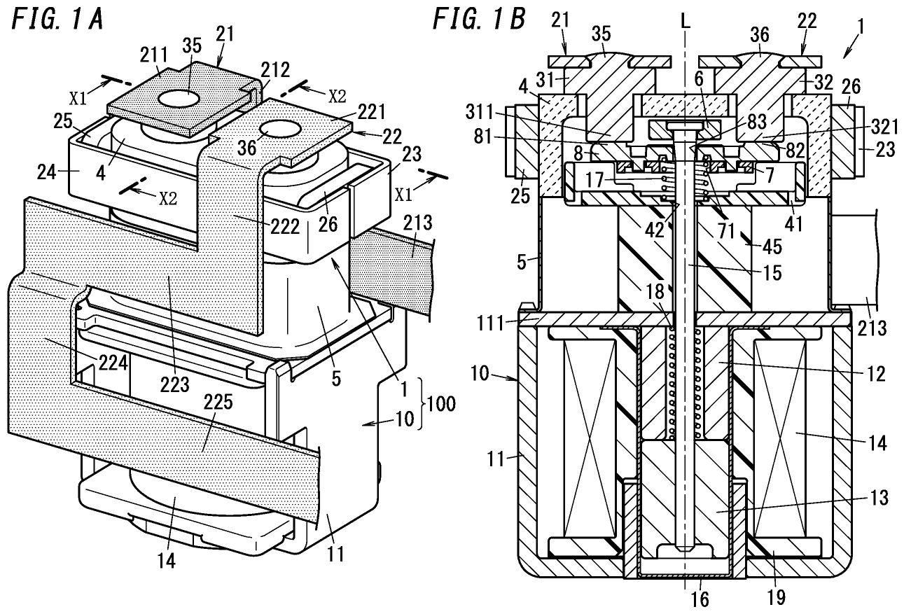

A contact device 1, an electromagnetic relay 100, an electric apparatus M1, and an electric apparatus case M10 according to the present embodiment will be described with reference to FIGS. 1A to 11.

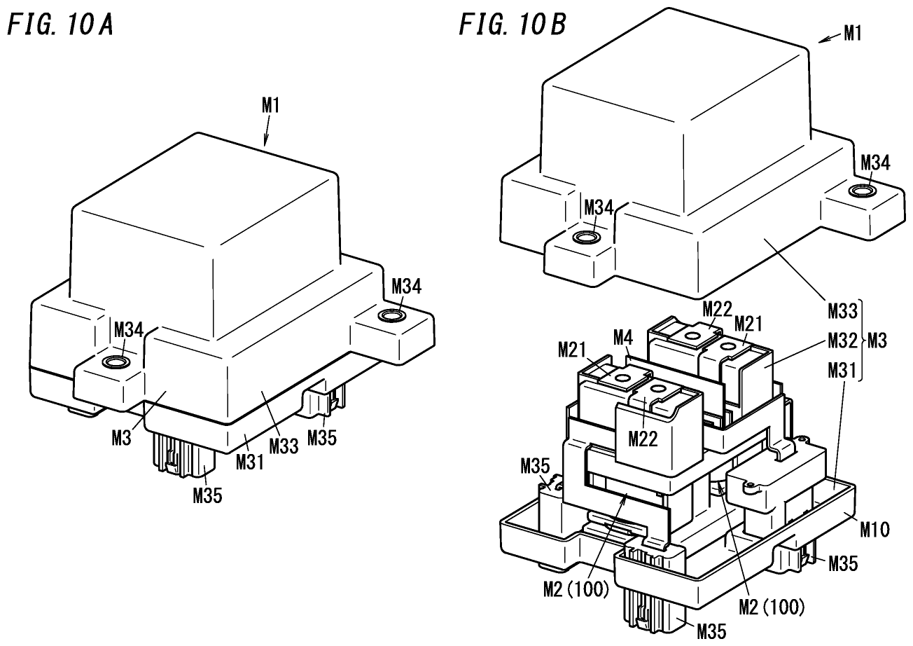

As illustrated in FIGS. 10A and 10B, the electric apparatus M1 according to the present embodiment includes: an inner device M2 constituted by the electromagnetic relay 100; and a housing M3 that holds the inner device M2.

The electric apparatus M1 further includes conductive bars M21 and M22. The conductive bars M21 and M22 are held by the housing M3. The conductive bars M21 and M22 correspond to conductive members. As used herein, the “conductive member” is a member for applying electromagnetic force to a movable element 13 (see FIG. 1B) of the electromagnetic relay 100, which is the inner device M2. A current flowing through the conductive member applies, to the movable element 13, force (magnetic force) oriented such that the movable element 13 is maintained at a location where the contact device 1 (see FIG. 1A) of the electromagnetic relay 100 is in a closed state, which will be described later in detail.

The housing M3 is, together with the conductive bars M21 and M22, included in the electric apparatus case M10. In other words, the electric apparatus case M10 includes the housing M3 and the conductive bars M21 and M22 held by the housing M3.

Moreover, in the present embodiment, one housing M3 holds two inner devices M2 constituted by electromagnetic relays 100. In other words, the electric apparatus M1 includes: two inner devices M2 each constituted by the electromagnetic relay 100; and the housing M3 which holds these two inner devices M2.

With reference to FIGS. 1A to 9, basic configurations, operation, and advantages of the contact device 1 and the electromagnetic relay 100 used in the electric apparatus M1 according to the present embodiment will be described at first below. Here, instead of the conductive bars M21 and M22, bus bars 21 and 22 electrically connected to the contact device 1 will be described as specific examples of the conductive members.

### (1) Configuration

(1.1) Electromagnetic Relay

The electromagnetic relay 100 according to the present embodiment includes the contact device 1, the electromagnetic device 10, and the two bus bars 21 and 22. The contact device 1 has a pair of fixed terminals 31 and 32 and a movable contactor 8 (see FIG. 1B). The fixed terminals 31 and 32 respectively have fixed contacts 311 and 321. The movable contactor 8 has a pair of movable contacts 81 and 82.

The electromagnetic device 10 includes the movable element 13 and an excitation coil 14 (see FIG. 1B). The electromagnetic device 10 attracts the movable element 13 by a magnetic field generated at the excitation coil 14 when the excitation coil 14 is energized. As the movable element 13 is attracted, the movable contactor 8 moves from an open position to a closed position. As used herein, the “open position” is a position of the movable contactor 8 where the movable contacts 81 and 82 are respectively apart from the fixed contacts 311 and 321. As used herein, the “closed position” is a position of the movable contactor 8 where the movable contacts 81 and 82 are respectively in contact with the fixed contacts 311 and 321.

Moreover, in the present embodiment, the movable element 13 is disposed on a straight line L and is configured to reciprocate rectilinearly along the straight line L. The excitation coil 14 is a conductor wire (electric wire) wound around the straight line L. That is, the straight line L corresponds to a central axis of the excitation coil 14.

In the present embodiment, a description is given of a case where the contact device 1 is, together with the electromagnetic device 10, included in the electromagnetic relay 100 as illustrated in FIG. 1A. However, application of the contact device 1 is not limited to application to the electromagnetic relay 100, but the contact device 1 may be used in, for example, a breaker (an interrupter), a switch, or the like. In the present embodiment, it is assumed that the electromagnetic relay 100 (electric apparatus M1) is mounted on an electric vehicle. In this case, the contact device 1 (the fixed terminals 31 and 32) is electrically connected to a feed path of direct-current power from a battery for driving to a load (e.g., an inverter).

(1.2) Contact Device

Next, a configuration of the contact device 1 will be described.

As illustrated in FIGS. 1A and 1B, the contact device 1 includes the pair of fixed terminals 31 and 32, the movable contactor 8, a housing 4, and a flange 5. The contact device 1 further includes a first yoke 6, a second yoke 7, two capsule yokes 23 and 24, two arc extinguishing magnets (permanent magnets) 25 and 26, an insulating plate 41, and a spacer 45. The fixed terminal 31 has the fixed contact 311, and the fixed terminal 32 has the fixed contact 321. The movable contactor 8 is a plate-like member made of a metal material which is conductive. The movable contactor 8 has the pair of movable contacts 81 and 82 respectively disposed to face the pair of fixed contacts 311 and 321. The pair of fixed terminals 31 and 32 are respectively electrically connected to the two bus bars 21 and 22. Moreover, the two bus bars 21 and 22 are not included in components of the contact device 1 in the present embodiment.

In the following description, a facing direction in which the fixed contacts 311 and 321 respectively face the movable contacts 81 and 82 is defined as an upward and downward direction for illustrative purposes, and a side on which the fixed contact 311 and 321 are located as viewed from the movable contacts 81 and 82 is defined as an upside. A direction in which the pair of fixed terminals 31 and 32 (the pair of fixed contacts 311 and 321) are aligned side by side is defined as a right and left direction, and a side on which the fixed terminal 32 is located as viewed from the fixed terminal 31 is defined as a right side. That is, the up, down, left, and right directions in FIG. 1B are used as up, down, left, and right directions in the following description. Moreover, in the following description, a direction orthogonal to both the upward and downward direction and the right and left direction (a direction orthogonal to a paper surface of FIG. 1B) is defined as a forward and rearward direction. However, these directions are not intended to limit the use form of the contact device 1 and the electromagnetic relay 100.

One (first) fixed contact 311 is held at a lower end (one end) of one (first) fixed terminal 31, and the other (second) fixed contact 321 is held at a lower end (one end) of the other (second) fixed terminal 32.

The pair of fixed terminals 31 and 32 are positioned to line up with each other in the right and left direction (see FIG. 1B). Each of the pair of fixed terminals 31 and 32 is made of an electrically conductive metal material. The pair of fixed terminals 31 and 32 function as terminals for connecting the pair of fixed contacts 311 and 321 to external circuits (a battery and a load). In the present embodiment, the fixed terminals 31 and 32 made of copper (Cu) are used as an example. However, materials for the fixed terminals 31 and 32 are not limited to copper. The fixed terminals 31 and 32 may be made of a conductive material other than copper.

Each of the pair of fixed terminals 31 and 32 is formed in a cylindrical shape having a round cross section in a flat plane orthogonal to the upward and downward direction. Here, each of the pair of fixed terminals 31 and 32 has a diameter at an upper end (the other end) larger than a diameter at the lower end (one end) and has a T-shape in front view. Each of the pair of fixed terminals 31 and 32 is held by the housing 4 with a part (the other end) protruding from an upper surface of the housing 4. Specifically, each of the pair of fixed terminals 31 and 32 is fixed to the housing 4 in a state where each of the pair of fixed terminals 31 and 32 penetrates through an opening pore formed in an upper wall of the housing 4.

The movable contactor 8 is in the shape of a plate having a thickness in the upward and downward direction and is longer in the right and left direction than in the forward and rearward direction. The movable contactor 8 is disposed under the pair of fixed terminals 31 and 32 such that both end portions in a longitudinal direction (right and left direction) of the movable contactor 8 face the pair of fixed contacts 311 and 321 (see FIG. 1B). The movable contactor 8 has portions which face the pair of fixed contacts 311 and 321 and which has the pair of movable contacts 81 and 82 (see FIG. 1B).

The movable contactor 8 is accommodated in the housing 4. The movable contactor 8 is moved in the upward and downward directions by the electromagnetic device 10 disposed in a lower part of the housing 4. In this way, the movable contactor 8 moves between the closed position and the open position. FIG. 1B shows a state where the movable contactor 8 is located in the closed position, and in this state, the pair of movable contacts 81 and 82 held by the movable contactor 8 are respectively in contact with the fixed contacts 311 and 321. In contrast, in a state where the movable contactor 8 is located in the open position, the pair of movable contacts 81 and 82 held by the movable contactor 8 are respectively apart from the fixed contacts 311 and 321.

Thus, when the movable contactor 8 is in the closed position, the pair of fixed terminals 31 and 32 are short-circuited to each other via the movable contactor 8. That is, when the movable contactor 8 is in the closed position, the movable contacts 81 and 82 are respectively in contact with the fixed contacts 311 and 321. Therefore, the fixed terminal 31 is electrically connected to the fixed terminal 32 via the fixed contact 311, the movable contact 81, the movable contactor 8, the movable contact 82, and the fixed contact 321. Thus, when the fixed terminal 31 is electrically connected to one of the battery and the load, and the fixed terminal 32 is electrically connected to the other of the battery and the load, the contact device 1 forms a feed path of direct-current power from the battery to the load when the movable contactor 8 is in the closed position.

Here, the movable contacts 81 and 82 are at least held by the movable contactor 8. Therefore, the movable contacts 81 and 82 may be configured integrally with the movable contactor 8 by embossing part of the movable contactor 8, or may be made as a member separated from the movable contactor 8 and may be fixed to the movable contactor 8 by, for example, welding. Similarly, the fixed contacts 311 and 321 are at least held respectively by the fixed terminals 31 and 32. Therefore, the fixed contacts 311 and 321 may respectively be configured integrally with the fixed terminals 31 and 32, or may be made as members separated from the fixed terminals 31 and 32 and may respectively be fixed to the fixed terminals 31 and 32 by, for example, welding.

The movable contactor 8 has a through hole 83 in its center portion. In the present embodiment, the through hole 83 is formed in the middle of the pair of movable contacts 81 and 82 of the movable contactor 8. The through hole 83 penetrates the movable contactor 8 in a thickness direction (the upward and downward direction). The through hole 83 is a hole which allows a shaft 15 which will be described later to pass therethrough.

The first yoke 6 is a ferromagnetic body and is made of a metal material such as iron. The first yoke 6 is fixed at a tip end (upper end) of the shaft 15. The shaft 15 penetrates the movable contactor 8 through the through hole 83 formed in the movable contactor 8. The tip end (the upper end) of the shaft 15 protrudes upward beyond an upper surface of the movable contactor 8. Therefore, the first yoke 6 is located above the movable contactor 8 (see FIG. 1B). Specifically, the first yoke 6 is, in a travel direction of the movable contactor 8, located on the same side as a side on which the fixed contacts 311 and 321 are provided with respect to the movable contactor 8.

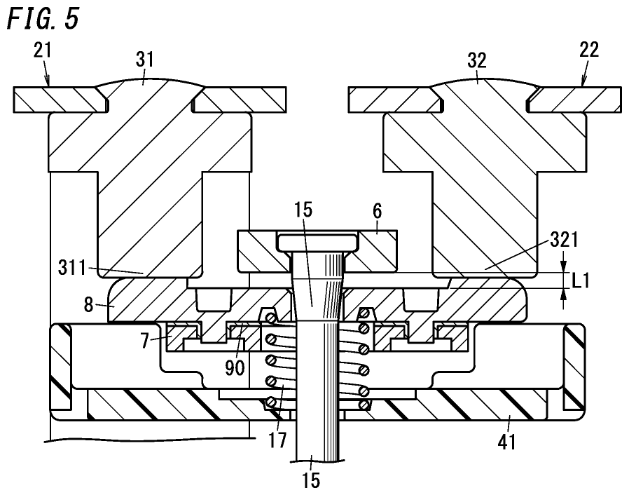

When the movable contactor 8 is located in the closed position, a gap L1 which is prescribed is formed between the movable contactor 8 and the first yoke 6 (see FIG. 5). That is, when the location of the movable contactor 8 is the closed position, the first yoke 6 is apart from the movable contactor 8 by the gap L1 in the upward and downward direction. For example, when the movable contactor 8, the shaft 15, and the first yoke 6 are at least partially electrically insulated from one another, electrical isolation is secured between the movable contactor 8 and the first yoke 6.

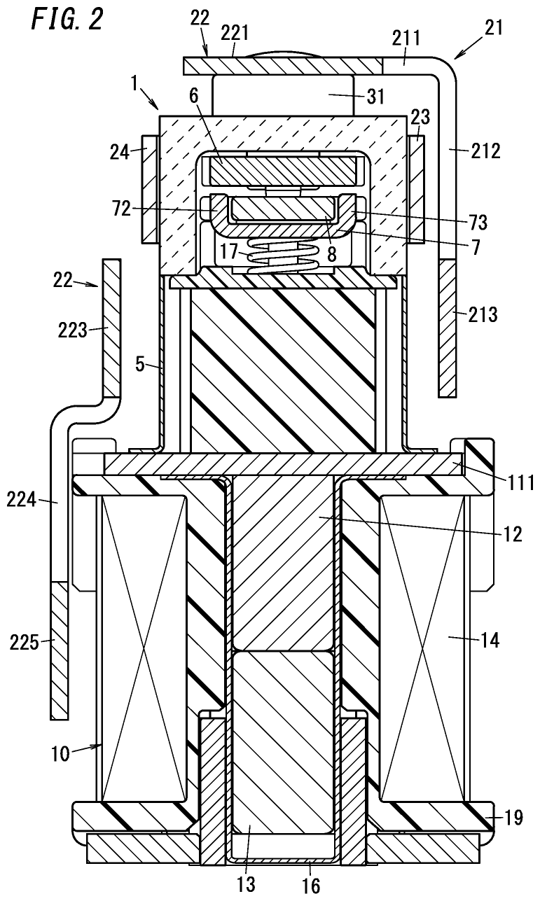

The second yoke 7 is a ferromagnetic body and is made of a metal material such as iron. The second yoke 7 is fixed to a lower surface of the movable contactor 8 (see FIG. 1B). Thus, the second yoke 7 moves in the upward and downward direction as the movable contactor 8 moves upward and downward. The second yoke 7 has an upper surface (in particular, a portion in contact with the movable contactor 8) which may be provided with an insulating layer 90 which is electrically insulating (see FIG. 5). This secures electrical insulation between the movable contactor 8 and the second yoke 7. In FIGS. 1B and 2, the illustration of the insulating layer 90 is accordingly omitted.

The second yoke 7 has a through hole 71 in its center portion. In the present embodiment, the through hole 71 is formed at a location corresponding to the through hole 83 formed in the movable contactor 8. The through hole 71 penetrates the second yoke 7 in a thickness direction (the upward and downward direction). The through hole 71 is a hole which allows the shaft 15 and a pressure spring 17 which will be described later to pass therethrough.

The second yoke 7 has both ends in the forward and rearward direction and has a pair of projections 72 and 73 (see FIG. 2) upwardly protruding at the ends. In other words, both ends of the upper surface of the second yoke 7 have the protections 72 and 73 protruding in an orientation the same as an orientation (in the present embodiment, upward) in which the movable contactor 8 moves from the open position to the closed position. That is, at least part of the second yoke 7 is, in the travel direction of the movable contactor 8, located on an opposite side of the movable contactor 8 from a side on which the fixed contacts 311 and 321 are present.

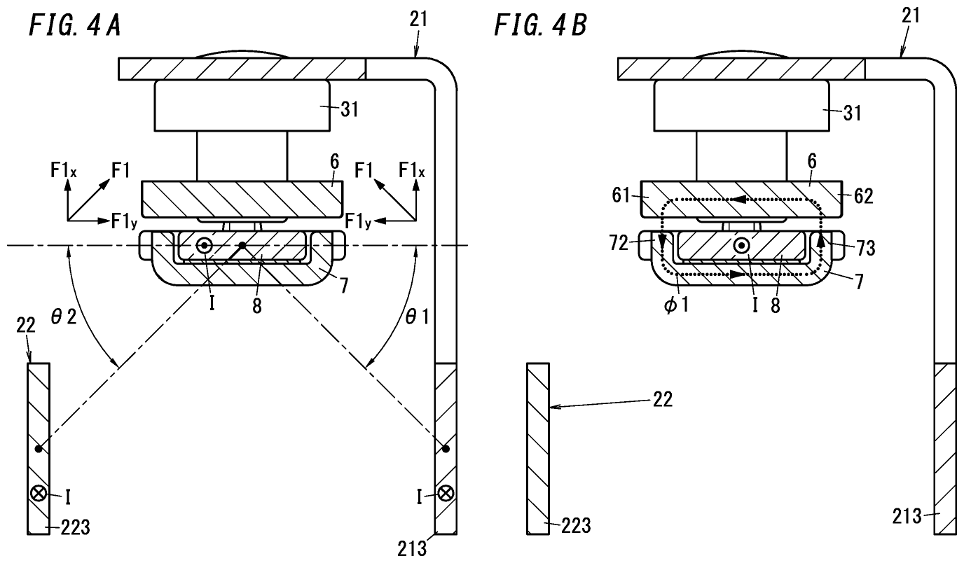

According to such a shape, as shown in FIG. 4B, the projection 72 of the pair of projections 72 and 73 which is at the front has a tip surface (upper end surface) which is to abut a front end 61 of the first yoke 6, and the projection 73 which is at the back has a tip surface (upper end surface) which is to abut a rear end 62 of the first yoke 6. Thus, when a current flows through the movable contactor 8 in an orientation illustrated in FIG. 4B, a magnetic flux φ1 passing through a flux path formed by the first yoke 6 and the second yoke 7 is generated. At this time, the front end 61 of the first yoke 6 and the tip surface of the projection 73 serve as N-poles, and the rear end 62 of the first yoke 6 and the tip surface of the projection 72 serve as S-poles, and thereby, attraction force acts between the first yoke 6 and the second yoke 7.

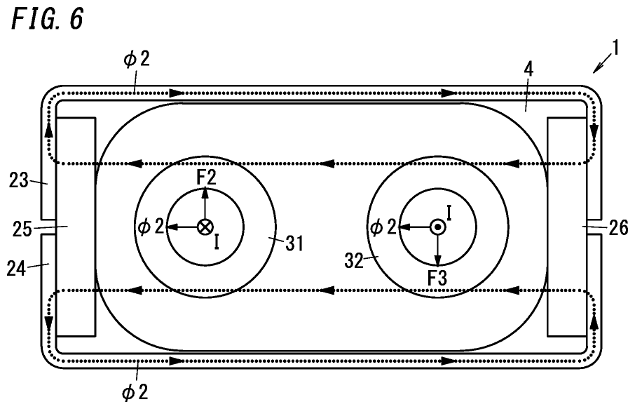

The capsule yokes 23 and 24 are ferromagnetic bodies and are made of a metal material such as iron. The capsule yokes 23 and 24 hold arc extinguishing magnets 25 and 26. The capsule yokes 23 and 24 are disposed on both sides in the forward and rearward direction with respect to the housing 4 so as to surround the housing 4 from both sides in the forward and rearward direction (see FIG. 6). In FIG. 6, the bus bars 21 and 22 are not shown.

The arc extinguishing magnets 25 and 26 are disposed such that their different poles face each other in the right and left direction. In other words, the arc extinguishing magnets 25 and 26 are located on an extension line in the direction of a current I flowing through the movable contactor 8. The arc extinguishing magnets 25 and 26 are located on both sides in the right and left direction with respect to the housing 4. The arc extinguishing magnet 25 extends an arc generated between the movable contact 81 and the fixed contact 311 when the movable contactor 8 moves from the closed position to the open position, and the arc extinguishing magnet 26 extends an arc generated between the movable contact 82 and the fixed contact 321 when the movable contactor 8 moves from the closed position to the open position. The capsule yokes 23 and 24 surround the housing 4 and also the arc extinguishing magnets 25 and 26. In other words, the arc extinguishing magnet 25 is sandwiched between one of both end surfaces in the light and left direction of the housing 4 and the capsule yokes 23 and 24, and the arc extinguishing magnet 26 is sandwiched between the other of the both end surfaces in the light and left direction of the housing 4 and the capsule yokes 23 and 24. The arc extinguishing magnet 25 (on the left) has one surface (left end face) and the other surface (right end surface) in the right and left direction, wherein the left end face is coupled to one end of each of the capsule yokes 23 and 24, and the right end face is coupled to the housing 4. The arc extinguishing magnet 26 (on the right) has one surface (right end face) and the other surface (left end face) in the right and left direction, wherein the right end face is coupled to the other end of each of the capsule yokes 23 and 24, and the left end face is coupled to the housing 4. The arc extinguishing magnets 25 and 26 are disposed such that their different poles face each other in the right and left direction. However, the arc extinguishing magnets 25 and 26 may be disposed such that the same poles face each other in the right and left direction.

In the present embodiment, when the location of the movable contactor 8 is the closed position, contact points of the pair of fixed contacts 311 and 321 with the pair of movable contacts 81 and 82 are located between the arc extinguishing magnet 25 and the arc extinguishing magnet 26 (see FIG. 1B). That is, the contact points of the pair of fixed contacts 311 and 321 with the pair of movable contacts 81 and 82 is included within a magnetic field generated between the arc extinguishing magnet 25 and the arc extinguishing magnet 26.

According to above-described configuration, as shown in FIG. 6, the capsule yoke 23 forms part of a magnetic circuit through which a magnetic flux φ2 generated by the pair of arc extinguishing magnets 25 and 26 passes. Similarly, the capsule yoke 24 forms part of the magnetic circuit through which a magnetic flux φ2 generated by the pair of arc extinguishing magnets 25 and 26 passes. These magnetic fluxes φ2 act on the contact points of the pair of fixed contacts 311 and 321 with the pair of movable contacts 81 and 82 in a state where the location of the movable contactor 8 is the closed position.

In the example shown in FIG. 6, it is assumed that a leftward magnetic flux φ2 is generated in an internal space of the housing 4, and a downward current I flows through the fixed terminal 31, and an upward current I flows through the fixed terminal 32. In this state, when the movable contactor 8 moves from the closed position to the open position, a downward discharge current (arc) from the fixed contact 311 toward the movable contact 81 is generated between the fixed contact 311 and the movable contact 81. Thus, the magnetic flux φ2 applies rearward Lorentz force F2 to the arc (see FIG. 6). That is, the arc generated between the fixed contact 311 and the movable contact 81 is extended backward to be extinguished. On the other hand, an upward discharge current (arc) from the movable contact 82 toward the fixed contact 321 is generated between the fixed contact 321 and the movable contact 82. Thus, the magnetic flux φ2 applies forward Lorentz force F3 to the arc (see FIG. 6). That is, the arc generated between the fixed contact 321 and the movable contact 82 is extended forward to be extinguished.

The housing 4 is made of ceramics such as aluminum oxide (alumina). The housing 4 is formed in a hollow rectangular parallelepiped shape (see FIG. 1B) that is longer in right and left direction than in the forward and rearward direction. The housing 4 has a lower surface having an opening. The housing 4 accommodates the pair of fixed contacts 311 and 321, the movable contactor 8, the first yoke 6, and the second yoke 7. The upper surface of the housing 4 has a pair of opening pores which allow the pair of fixed terminals 31 and 32 to pass therethrough. Each of the pair of opening pores is formed in a round shape and penetrates the upper wall of the housing 4 in the thickness direction (upward and downward direction). The fixed terminal 31 passes through one of the opening pores, and the fixed terminal 32 passes through the other of the opening pores. The pair of fixed terminals 31 and 32 and the housing 4 are coupled by brazing.

The housing 4 is at least formed in a box-like shape that accommodates the pair of fixed contacts 311 and 321 and the movable contactor 8. The housing 4 is not limited to a hollow rectangular parallelepiped as shown in the present embodiment. For example, the housing 4 may have a hollow ellipse cylindrical shape, a hollow polygonal prism shape, or the like. That is, the box-like shape mentioned herein means a general shape having a space for accommodating the pair of fixed contacts 311 and 321 and the movable contactor 8 in an interior thereof, and is not intended to be limited to the rectangular parallelepiped. The housing 4 is not limited to a housing made of ceramics but may be made of an insulative material such as glass or a resin or may be made of metal. The housing 4 is preferably made of a non-magnetic material which does not become a magnetic body by magnetism.

The flange 5 is made of a non-magnetic metal material. The non-magnetic metal material is austenite-based stainless steel such as SUS304. The flange 5 has a hollow rectangular parallelepiped shape elongated in the right and left direction. An upper surface and a lower surface of the flange 5 are openings. The flange 5 is disposed between the housing 4 and the electromagnetic device 10 (see FIGS. 1B and 2). The flange 5 is hermetically bound to the housing 4 and a yoke upper board 111, which will be described later in detail, of the electromagnetic device 10. Thus, an internal space of the contact device 1 surrounded by the housing 4, the flange 5, and the yoke upper board 111 can be an airtight space. The flange 5 does not have to be non-magnetic but may made of an alloy, such as a 42-alloy, containing iron as a main component.

The insulating plate 41 is made of a synthetic resin and is electrically insulating. The insulating plate 41 has a rectangular plate shape. The insulating plate 41 is located below the movable contactor 8 and electrically isolates the movable contactor 8 from the electromagnetic device 10. The insulating plate 41 has a through hole 42 in its center portion. In the present embodiment, the through hole 42 is formed at a location corresponding to the through hole 83 in the movable contactor 8. The through hole 42 penetrates the insulating plate 41 in a thickness direction (the upward and downward direction). The through hole 42 is a hole which allows the shaft 15 to pass therethrough.

The spacer 45 has a cylindrical shape. The spacer 45 is made of, for example, a synthetic resin. The spacer 45 is disposed between the electromagnetic device 10 and the insulating plate 41. The spacer 45 has an upper end which is coupled to a lower surface of the insulating plate 41. the spacer 45 has a lower end which is coupled to electromagnetic device 10. The insulating plate 41 is supported by the spacer 45. The shaft 15 is inserted into a hole formed in the spacer 45.

The bus bars 21 and 22 are made of a metal material which is conductive. The bus bars 21 and 22 are made of, for example, copper or a copper alloy. The bus bars 21 and 22 each has a strip plate shape. In the present embodiment, the bus bars 21 and 22 are formed by subjecting a metal plate to a bending process. One end in a longitudinal direction of the bus bar 21 is electrically connected to, for example, the fixed terminal 31 of the contact device 1. The other end in the longitudinal direction of the bus bar 21 is electrically connected to, for example, a running battery. One end in a longitudinal direction of the bus bar 22 is electrically connected to, for example, the fixed terminal 32 of the contact device 1. The other end in the longitudinal direction of the bus bar 22 is electrically connected to, for example, a load.

The bus bar 21 includes three electrical path segments 211, 212, and 213. The electrical path segment 211 is mechanically connected to the fixed terminal 31. Specifically, the electrical path segment 211 has a substantially square shape in plan view and is coupled to the fixed terminal 31 by swaging at a swage section 35 of the fixed terminal 31. The electrical path segment 212 (extension piece) is coupled to the electrical path segment 211 and is disposed behind the housing 4 so as to extend downward from a rear end of the electrical path segment 211. The electrical path segment 213 (first electrical path segment) is connected to the electrical path segment 212 and is disposed behind the housing 4 so as to extend from a lower end of the electrical path segment 212 to the right (toward the fixed terminal 32 as viewed from the fixed terminal 31). The thickness direction (forward and rearward direction) of the electrical path segment 213 is orthogonal to the travel direction (upward and downward direction) of the movable contactor 8 (see FIGS. 1A and 2).

The bus bar 22 includes five electrical path segments 221, 222, 223, 224, and 225. The electrical path segment 221 is mechanically connected to the fixed terminal 32. Specifically, the electrical path segment 221 has a substantially square shape in plan view and is coupled to the fixed terminal 32 by swaging at a swage section 36 of the fixed terminal 32. The electrical path segment 222 (extension piece) is coupled to the electrical path segment 221 and is disposed in front of the housing 4 so as to extend downward from a rear end of the electrical path segment 221. The electrical path segment 223 (second electrical path segment) is coupled to the electrical path segment 222 and is disposed in front of the housing 4 so as to extend from a lower end of the electrical path segment 222 to the left (toward the fixed terminal 31 as viewed from the fixed terminal 32). The thickness direction (forward and rearward direction) of the electrical path segment 223 is orthogonal to the travel direction (upward and downward direction) of the movable contactor 8.

That is, the fixed contacts 311 and 321 are respectively provided at ends on one side (lower ends) of the fixed terminals 31 and 32. The bus bars 21 and 22 are respectively fixed to ends on the other side (upper ends) of the fixed terminals 31 and 32. As used herein, “fix” includes various ways of mechanical connections and includes, for example, screwing, welding, and brazing, in addition to swaging.

The electrical path segment 224 is connected to the electrical path segment 223 and is disposed in front of the electromagnetic device 10 so as to extend downward from a left end of the electrical path segment 223. The electrical path segment 225 is connected to the electrical path segment 224 and is disposed in front of the electromagnetic device 10 so as to extend from a lower end of the electrical path segment 224 to the right (toward the fixed terminal 32 as viewed from the fixed terminal 31). The thickness direction (forward and rearward direction) of the electrical path segment 225 is orthogonal to the travel direction (upward and downward direction) of the movable contactor 8.

Here, the bus bars 21 and 22 are rigid. Therefore, one end (electrical path segment 211) in the longitudinal direction of the bus bar 21 is mechanically connected to the fixed terminal 31 to achieve a state where the entirety of the bus bar 21 is supported by the fixed terminal 31, and one end (electrical path segment 221) in the longitudinal direction of the bus bar 22 is mechanically connected to the fixed terminal 32 to achieve a state where the entirety of the bus bar 22 is supported by the fixed terminal 32. This makes the other end (electrical path segment 213) in the longitudinal direction of the bus bar 21, and the other end (electrical path segment 225) in the longitudinal direction of the bus bar 22 free-standing. Thus, the bus bars 21 and 22 have structures integrated respectively with the fixed terminals 31 and 32.

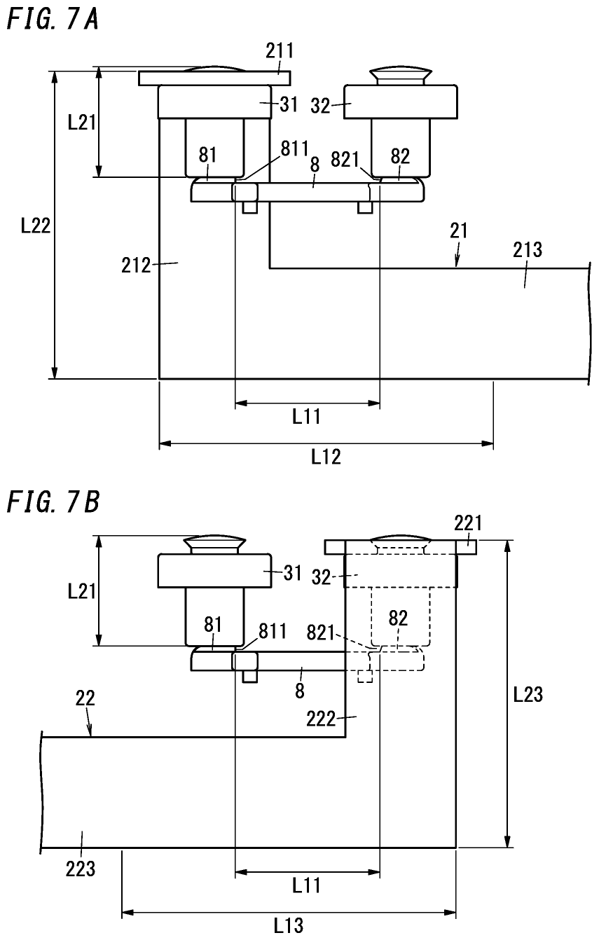

The length L22 of the electrical path segment 212 and the length L23 of the electrical path segment 222 are each longer than or equal to the length L21 of the fixed terminals 31 and 32 in the upward and downward direction (see FIGS. 7A and 7B). In FIGS. 7A and 7B, the length L21 is a dimension from an upper end edge of the fixed terminal 31 (or 32) to a lower end edge of the fixed terminal 31 (or 32) (including the fixed contact 311 (or 321)). However, the length L21 that should be in the above-described dimensional relationship with respect to the lengths L22 and L23 is at least a length from a connecting portion of the fixed terminal 31 (32) to the bus bar 21 (22) to the holding portion of the fixed contact 311 (321) of the fixed terminal 31 (32).

Here, when the movable contactor 8 is located in the closed position, the movable contactor 8 is located among the electrical paths 213 and 223 and the fixed contacts 311 and 321 as viewed in one of the forward and rearward directions. In order to achieve such a positional relationship, the electrical path segments 213 and 223 are disposed on an outer side of the housing 4 to be substantially parallel to the movable contactor 8 (FIG. 1B and see FIG. 2). In other words, regarding the electrical path segments 213 and 223, when the movable contactor 8 is located in the closed position, the movable contactor 8 is located among the electrical path segments 213 and 223 and the fixed contacts 311 and 321 in the travel direction (upward and downward direction) of the movable contactor 8.

In the present embodiment, as shown in FIG. 4A, in a cross section orthogonal to the right and left direction, an angle θ1 between a straight line connecting a center point of the electrical path segment 213 to a center point of the movable contactor 8 and a straight line along the forward and rearward direction is 45 degrees. Similarly, in a cross section orthogonal in the right and left direction, an angle θ2 between a straight line connecting a center point of the electrical path segment 223 to the center point of the movable contactor 8 and the straight line along the forward and rearward direction is equal to the angle θ1 (here, 45 degrees). Here, the term “equal” includes not only perfect matching but also cases where an error of about several degrees is within an allowable range. The above value (45 degrees) is one example, and the angle is not limited to this value. In FIG. 4A, in order to avoid overlapping of the center point of the movable contactor 8 in the cross section and the notation of the current I, the notation of the contact I is indicated at a location shifted from the center point of the movable contactor 8 in the cross section but is not intended to identify the location where the current I actually flows. The same applies to the notation of currents I flowing through the electrical path segments 213 and 223.

Moreover, the electrical path segments 213 and 223 are disposed between the yoke upper board 111 of the yoke 11 which will be described later and the movable contactor 8 in the closed position.

Each of the length L12 of the electrical path segment 213 and the length L13 of electrical path segment 223 is longer than or equal to the distance L11 between the movable contact 81 and the movable contact 82 (FIGS. 7A and 7B). Here, the distance L11 between the movable contact 81 and the movable contact 82 is the shortest distance between the movable contact 81 and the movable contact 82.

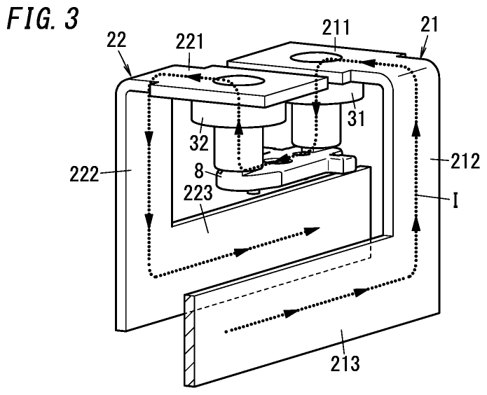

In the present embodiment, the electrical path segment 213 extends (protrudes) rightward from the electrical path segment 212, and the electrical path segment 223 extends (protrudes) leftward from the electrical path segment 222. Here, it is assumed at first that the current I flows through the movable contactor 8 from the fixed terminal 31 toward the fixed terminal 32. At this time, the current I flows in the order of the electrical path segment 213, the electrical path segment 212, the electrical path segment 211, the fixed terminal 31, the movable contactor 8, the fixed terminal 32, the electrical path segment 221, the electrical path segment 222, and the electrical path segment 223 (see FIG. 3). In the electrical path segments 213 and 223, the current I flows leftward (toward the fixed terminal 31 as viewed from the fixed terminal 32). On the other hand, in the movable contactor 8, the current I flows rightward (toward the fixed terminal 32 as viewed from the fixed terminal 31). In contrast, if the current I flows through the movable contactor 8 from the fixed terminal 32 to the fixed terminal 31, the current I flows rightward through the electrical path segments 213 and 223, and the current I flows leftward through the movable contactor 8.

That is, when the orientation in which the electrical path segment 213 extends (protrudes) from the electrical path segment 212 is opposite to the orientation in which the electrical path segment 223 extends (protrudes) from the electrical path segment 222, the orientation of the current I flowing through the electrical path segment 213 and the electrical path segment 223 is opposite to the orientation of the current I flowing through the movable contactor 8. In other words, when the movable contactor 8 is located in the closed position, the electrical path segments 213 and 223 constitute backward electrical path segments which are located on an opposite side of the movable contactor 8 from the fixed contacts 311 and 321 in the travel direction of the movable contactor 8 and which allow a current I to flow therethrough oppositely to the current I flowing through the movable contactor 8. Thus, the bus bars 21 and 22 respectively include the electrical path segments 213 and 223 as upper electrical path segments in which the current I flows oppositely to the orientation in which the current I flows through the movable contactor 8. The upper electrical path segments (the electrical path segments 213 and 223) are located on the same side (upper side) as the movable contactor 8 with respect to the excitation coil 14.

Here, the electrical path segments 213 and 223 have shapes extending along the direction of the current I flowing through the movable contactor 8. In the present embodiment, the direction of the current I flowing through the movable contactor 8 is, on the upper surface of the movable contactor 8, an extension direction of a straight line connecting a center point of the movable contact 81 to a center point of the movable contact 82, that is, the right and left direction. Moreover, the electrical path segments 212 and 222 have shapes extending along directions of the current I flowing through the fixed terminals 31 and 32. In the present embodiment, the direction of the current I flowing through the fixed terminals 31 and 32 is a central axis direction of the fixed terminal 31 or the fixed terminal 32, that is, the upward and downward direction.

In the present embodiment, the electrical path segment 213, which is the inverse direction electrical path segment, is located behind the housing 4, and the electrical path segment 223, which is the inverse direction electrical path segment, is located in front of the housing 4. That is, the bus bars 21 and 22, which are conductive members, include a pair of inverse direction electrical path segments (electrical path segments 213 and 223), and the movable contactor 8 is located between the pair of inverse direction electrical path segments (electrical path segments 213 and 223) as viewed from one side in the travel direction of the movable contactor 8.

As used herein, “extending along the direction of a current” means that the electrical path segment 213 is provided such that an angle in a projection direction of the electrical path segment 213 to the direction of the current I flowing through the movable contactor 8 of the contact device 1 is in a predetermined range (greater than or equal to 0 degrees and less than or equal to 45 degrees). That is, in the vector of a current flowing through the electrical path segment 213, the electrical path segment 213 is provided such that a component parallel to the vector of the current I flowing through the movable contactor 8 of the contact device 1 is larger than a component orthogonal to the direction of the current I flowing through the movable contactor 8 of the contact device 1. Moreover, the angle in the projection direction of the electrical path segment 213 to the direction of the current I flowing through the movable contactor 8 of the contact device 1 is preferably in a predetermined range (greater than or equal to 0 degrees and less than or equal to 25 degrees). In a specific example, the electrical path segment 213 of the contact device 1 extends parallel to the direction of the current I flowing through the movable contactor 8 of the contact device 1.

Moreover, the orientation of the current flowing through the electrical path segment 212 is opposite to the orientation of the current I flowing through the fixed terminal 31. Furthermore, the orientation of the current flowing through the electrical path segment 222 is opposite to the orientation of the current I flowing through the fixed terminal 32. Specifically, it is assumed that a current I flows from the fixed terminal 31 to the fixed terminal 32. In this case, the current I flows upward in the electrical path segment 212, and the current I flows downward in the fixed terminal 31. In the electrical path segment 222, the current I flows downward, and in the fixed terminal 32, the current I flows upward.

Moreover, as illustrated in FIG. 1A, the electrical path segments 213, 223, and the arc extinguishing magnets 25 and 26 are disposed so as to be aligned in the order of the arc extinguishing magnets 25 and 26 and the electrical path segments 213 and 223 from the top in the travel direction (upward and downward direction) of the movable contactor 8. In other words, in the upward and downward direction, the electrical path segments 213 and 223 are respectively located below the arc extinguishing magnets 25 and 26.

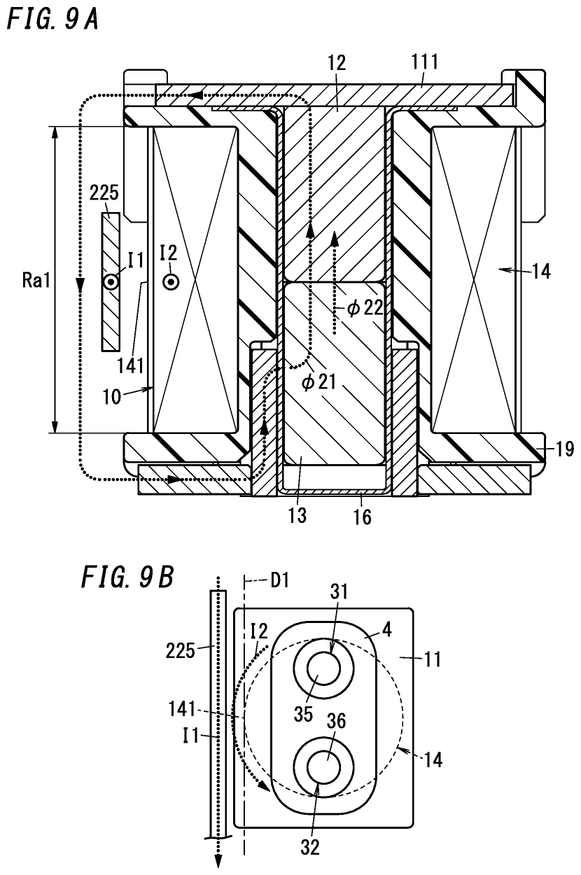

Moreover, in the present embodiment, the electrical path segment 225 extends rightward from the electrical path segment 224. Here, it is assumed at first that a current I1 flows through the movable contactor 8 from the fixed terminal 31 toward the fixed terminal 32. At this time, the current I1 flows through the fixed terminal 32, the electrical path segment 221, the electrical path segment 222, the electrical path segment 223, the electrical path segment 224, and the electrical path segment 225 in this order. At this time, as shown in FIGS. 9A and 9B, in the electrical path segment 225, the current I1 flows rightward (toward the fixed terminal 32 as viewed from the fixed terminal 31). In this case, in the excitation coil 14, it is assumed that a current I2 flows anticlockwise when viewed from above. As a result, in a portion of the excitation coil 14 facing the electrical path segment 225 (a front surface side of the excitation coil 14), the current I2 flows rightward (toward the fixed terminal 32 as viewed from the fixed terminal 31). FIG. 9A is a conceptual view which is a cross sectional view similar to that in FIG. 2 and in which the contact device 1 is omitted.

In contrast, when the current I1 flows through the movable contactor 8 from the fixed terminal 32 to the fixed terminal 31, the current I1 flows leftward in the electrical path segment 225. In this case, in the excitation coil 14, it is assumed that the current I2 flows clockwise when viewed from above. As a result, in a portion of the excitation coil 14 facing the electrical path segment 225 (a front surface side of the excitation coil 14), the current I2 flows leftward.

That is, in the present embodiment, the electrical path segment 225 extends along a tangent line direction D1 of a part 141 in a circumferential direction of the excitation coil 14, as seen from one side (above) in the axial direction of the excitation coil 14 as shown in FIGS. 9A and 9B. Here, the orientation of the current I1 flowing through the electrical path segment 225 is the same as the orientation of the current I2 flowing through the part 141 in the circumferential direction of the excitation coil 14 when the excitation coil 14 is energized. In the present embodiment, the part 141 in the circumferential direction of the excitation coil 14 is a front end of the excitation coil 14 located in front of the central axis of the excitation coil 14. Thus, the tangent line direction D1 of the part 141 is the right and left direction. In FIG. 9B, “tangent line” is denoted by a long dashed short dashed line, and symbol “D1” of “tangent line direction” is attached to the “tangent line”.

Moreover, in the present embodiment, in the travel direction (upward and downward direction) of the movable element 13 of the electromagnetic device 10, the electrical path segment 225, which is at least part of the bus bar 22, is located between both ends of the excitation coil 14. That is, the electrical path segment 225 is disposed within a range Ra1, namely, between an upper end edge of the excitation coil 14 and a lower end edge of the excitation coil 14 (see FIG. 9A).

Moreover, the electrical path segment 225 is located on an opposite side of the yoke upper board 111 of the yoke 11 from the electrical path segment 223 in the upward and downward direction. That is, in the upward and downward direction, the yoke upper board 111 is located between the electrical path segment 225 and the electrical path segment 223.

(1.3) Electromagnetic Device

Next, the configuration of the electromagnetic device 10 will be described.

The electromagnetic device 10 is disposed under the movable contactor 8. As illustrated in FIGS. 1A and 1B, the electromagnetic device 10 includes a stator 12, the movable element 13, and the excitation coil 14. The electromagnetic device 10 attracts the movable element 13 to the stator 12 by a magnetic field generated at the excitation coil 14 when the excitation coil 14 is energized, and the electromagnetic device 10 moves the movable element 13 upward.

Here, in addition to the stator 12, the movable element 13, and the excitation coil 14, the electromagnetic device 10 includes the yoke 11 including the yoke upper board 111, the shaft 15, a tube body 16, the pressure spring 17, a return spring 18, and a coil bobbin 19.

The stator 12 is a fixed iron core having a cylindrical shape projecting downward from a lower surface central part of the yoke upper board 111. The stator 12 has an upper end fixed to the yoke upper board 111.

The movable element 13 is a movable iron core having a cylindrical shape. The movable element 13 is disposed under the stator 12 such that an upper end surface of the movable element 13 faces a lower end surface of the stator 12. The movable element 13 is configured to be movable in the upward and downward direction. The movable element 13 moves between an excitation location (see FIGS. 1B and 2) where the upper end surface of the movable element 13 is in contact with the lower end surface of the stator 12 and a non-excitation location where the upper end surface of the movable element 13 is apart from the lower end surface of the stator 12. As used herein, the “excitation location” is a location of the movable element 13 when the excitation coil 14 is energized. As used herein, the “non-excitation location” is a location of the movable element 13 when the excitation coil 14 is de-energized.

The excitation coil 14 is disposed under the housing 4 in an orientation in which a central axis direction of the excitation coil 14 matches with the upward and downward direction. The stator 12 and the movable element 13 are disposed on an inner side of the excitation coil 14. The excitation coil 14 is electrically isolated from the contact device 1. That is, the excitation coil 14 is electrically insulated from the bus bars 21 and 22 as conductive members electrically connected to the fixed terminals 31 and 32 of the contact device 1.

The yoke 11 is disposed to surround the excitation coil 14 and forms, together with the stator 12 and the movable element 13, a magnetic circuit through which a magnetic flux generated when the excitation coil 14 is energized passes. Therefore, all of the yoke 11, the stator 12, and the movable element 13 are made of a magnetic material (ferromagnetic body). The yoke upper board 111 is part of the yoke 11. In other words, at least part (the yoke upper board 111) of the yoke 11 is located between the excitation coil 14 and the movable contactor 8.

The pressure spring 17 is located between the lower surface of the movable contactor 8 and an upper surface of the insulating plate 41. The pressure spring 17 is a coil spring (see FIG. 1B) that urges the movable contactor 8 upward.

The return spring 18 is at least partially disposed on an inner side of the stator 12. The return spring 18 is a coil spring that urges the movable element 13 downward (to the non-excitation location). The return spring 18 has one end connected to the upper end surface of the movable element 13, and the other end of the return spring 18 is connected to the yoke upper board 111 (see FIG. 1B).

The shaft 15 is made of a non-magnetic material. The shaft 15 has a round rod shape extending in the upward and downward direction. The shaft 15 transmits driving force generated by electromagnetic device 10 to the contact device 1 provided above the electromagnetic device 10. The shaft 15 extends through the through hole 83, the through hole 71, an inner side of the pressure spring 17, the through hole 42, a through hole formed in a central part of the yoke upper board 111, an inner side of the stator 12, and an inner side of the return spring 18. The shaft 15 has a lower end fixed to the movable element 13. The upper end of the shaft 15 is fixed to the first yoke 6.

The coil bobbin 19 is made of a synthetic resin and is wound with an excitation coil 14.

Note that the tube body 16 has a bottomed cylindrical shape in which an upper surface is an opening. The tube body 16 has an upper end (opening circumference) bound to a lower surface of the yoke upper board 111. Thus, the tube body 16 restricts the travel direction of the movable element 13 in the upward and downward direction and specifies the non-excitation location of the movable element 13. The tube body 16 is hermetically bound to the lower surface of the yoke upper board 111. Thus, even if a through hole is formed in the yoke upper board 111, it is possible to secure the airtightness of the internal space of the contact device 1 surrounded by the housing 4, the flange 5, and the yoke upper board 111.

With this configuration, the movable contactor 8 moves in the upward and downward direction as the movable element 13 moves in the upward and downward direction by the driving force generated in the electromagnetic device 10.

### (2) Operation

Next, a brief description will be given of operation of the electromagnetic relay 100 including the contact device 1 and the electromagnetic device 10 having the above-described configurations.

When the excitation coil 14 is not energized (de-energized), magnetic attraction force is not generated between the movable element 13 and the stator 12. Therefore, the movable element 13 is located in the non-excitation location by spring force of the return spring 18. At this time, the shaft 15 is pulled downward. The shaft 15 restricts upward movement of the movable contactor 8. This causes the movable contactor 8 to be located in the open position, which is a lower end location within its movable range. Therefore, the pair of movable contacts 81 and 82 are apart from the pair of fixed contacts 311 and 321, and the contact device 1 is in the open state. In this state, the pair of fixed terminals 31 and 32 are not electrically connected to each other.

On the other hand, when the excitation coil 14 is energized, magnetic attraction force is generated between the movable element 13 and the stator 12. Therefore, the movable element 13 is attracted upward against the spring force of the return spring 18 and moves to the excitation location. In other words, the electromagnetic device 10 attracts the movable element 13 to the stator 12 by a magnetic field generated at the excitation coil 14 when the excitation coil 14 is energized and moves the movable element 13 from a non-excitation location to an excitation location. At this time, since the shaft 15 is pushed upward, the upward movement restriction of the movable contactor 8 by the shaft 15 is released. Then, the pressure spring 17 urges the movable contactor 8 upward, thereby moving the movable contactor 8 to the closed position, which is the upper end location within the movable range. Therefore, the pair of movable contacts 81 and 82 come into contact with the pair of fixed contacts 311 and 321, and the contact device 1 is in the closed state. In this state, since the contact device 1 is in the closed state, the pair of fixed terminals 31 and 32 are electrically connected to each other.

Thus, the electromagnetic device 10 switches an energization state of the excitation coil 14 to control attraction force acting on the movable element 13 and moves the movable element 13 in the upward and downward direction, thereby generating driving force for switching the contact device 1 between the open state and the closed state. In the present embodiment, the electromagnetic relay 100 is a so-called normally-off electromagnetic relay, in which the movable contactor 8 is located in the open position when the excitation coil 14 is de-energized. Therefore, the contact device 1 is in the open state when the movable element 13 is located in the non-excitation location, and the contact device 1 is in the closed state when the movable element 13 is in the excitation location.

### (3) Advantages

Here, advantages derived from provision of the bus bars 21 and 22 described above and advantages derived from provision of the first yoke 6 and the second yoke 7 will be described.

When the excitation coil 14 is energized, the movable element 13 moves from the non-excitation location to the excitation location as described above in the electromagnetic device 10. At this time, due to the driving force generated by the electromagnetic device 10, the movable contactor 8 moves upward and moves from the open position to the closed position. Thus, the movable contacts 81 and 82 come into contact with the fixed contacts 311 and 321, and the contact device 1 is brought into the closed state. If the contact device 1 is in the closed state, the movable contacts 81 and 82 are pressed against the fixed contacts 311 and 321 by the pressure spring 17.

By the way, when the contact device 1 is in the closed state, a current flowing through the contact device 1 (between the fixed terminals 31 and 32) may cause electromagnetic repulsion force that pulls the movable contacts 81 and 82 respectively away from the fixed contacts 311 and 321. That is, when the current flows through the contact device 1, Lorentz force may apply, to the movable contactor 8, the electromagnetic repulsion force in an orientation (downward) in which the movable contactor 8 is moved from the closed position to the open position. Since the electromagnetic repulsion force in a normal mode is smaller than spring force of the pressure spring 17, the movable contactor 8 maintains a state where the movable contacts 81 and 82 are in contact with the fixed contacts 311 and 321. However, for example, when a very large (e.g., about 6 kA) current (anomalous electric current) such as a short-circuit current flows through the contact device 1, the electromagnetic repulsion force acting on the movable contactor 8 may exceeds the spring force of the pressure spring 17. In the present embodiment, as a measure against such an electromagnetic repulsion force, a current flowing through the bus bars 21 and 22 is used first.

That is, in the contact device 1 according to the present embodiment, the bus bars 21 and 22 respectively include the electrical path segments 213 and 223 through which the current I flows in an orientation opposite to an orientation in which the current I flows through the movable contactor 8. Therefore, when the anomalous electric current such as a short-circuit current flows through the contact device 1, repulsion force F1 is generated between the electrical path segment 213 and the movable contactor 8 and between the electrical path segment 223 and the movable contactor 8 (see FIG. 4A). As used herein, the “repulsion force F1” refers to force which is included in some types of force interacting with each other between the movable contactor 8 and the electrical path segments 213 and 223 and which is in an orientation in which the movable contactor 8 is separated from the electrical path segments 213 and 223. Such repulsion force F1 is force applied by Lorentz force to the current I flowing through the movable contactor 8 and the electrical path segments 213 and 223.

In the present embodiment, when the movable contactor 8 is located in the closed position, the movable contactor 8 is located among the electrical path segments 213 and 223 and the fixed contacts 311 and 321 in the travel direction of the movable contactor 8 (upward and downward direction). Since the electrical path segments 213 and 223 are respectively fixed to the fixed terminals 31 and 32, the electrical path segments 213 and 223 do not move relatively with respect to the housing 4. On the other hand, the movable contactor 8 is movable in the upward and downward direction with respect to the housing 4. Therefore, of a force component F1x in the upward and downward direction and a force component Fly in the forward and rearward direction of the repulsion force F1, the force component F1x is applied to the movable contactor 8 (see FIG. 4A). This increases force that pushes the movable contactor 8 upward, that is, force that pushes the movable contacts 81 and 82 against the fixed contacts 311 and 321. In other words, a magnetic field generated by the current I flowing through the bus bars 21 and 22 (conductive members) located on an outer side of the housing 4 when the movable contactor 8 is located in the closed position applies, to the movable contactor 8, force oriented such that the movable contactor 8 is maintained in the closed position in the travel direction of the movable contactor 8. In this embodiment, an upward force component F1x of the repulsion force F1 corresponds to the force oriented such that the movable contactor 8 is maintained in the closed position.

Thus, even when an anomalous electric current such as a short-circuit current flows to a contact device 1e, it is possible to stabilize the connection state between the movable contacts 81 and 82 and the fixed contacts 311 and 321.

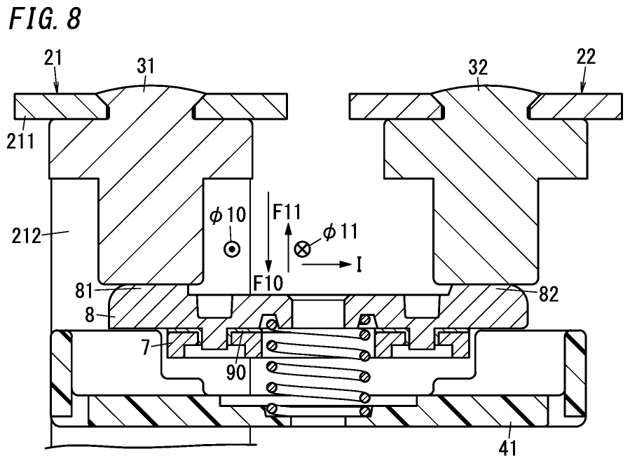

Moreover, in the contact device 1 according to the present embodiment, the bus bars 21 and 22 respectively include the electrical path segments 212 and 222 through which the current I flows in an orientation opposite to an orientation in which the current I flows through the fixed terminals 31 and 32. Here, as illustrated in FIG. 3, it is assumed that the current I flows from the fixed terminal 31 toward the fixed terminal 32. In this case, in the fixed terminal 31, a downward flow of the current I causes a clockwise magnetic flux φ10 (see FIG. 8) in plan view (viewed from above) with the fixed terminal 31 as the center. On the other hand, in the electrical path segment 212, an upward flow of the current I causes an anticlockwise magnetic flux φ11 (see FIG. 8) in plan view (viewed from above) with the electrical path segment 212 as the center.

At this time, from the relationship between a rightward current I flowing through the movable contactor 8 and the magnetic flux φ10, a downward Lorentz force F10 acts on the movable contactor 8. Moreover, from the relationship between a rightward current I flowing through the movable contactor 8 and the magnetic flux φ11, upward Lorentz force F11 acts on the movable contactor 8. That is, when the contact device 1 is provided with the electrical path segment 212, it is possible to generate the upward Lorentz force F11. This cancels at least part of the downward Lorentz force F10, so that it is possible to reduce the force for moving the movable contactor 8 downward.

Moreover, in a similar manner, also from the relationship between a magnetic flux generated by a current I flowing through the fixed terminal 32 and a magnetic flux generated by a current I flowing through the electrical path segment 222, it is possible to cancel at least part of the downward Lorentz force acting on the movable contactor 8. That is, the electrical path segment 222 enables the force for moving the movable contactor 8 downward to be reduced.

Thus, even when an anomalous electric current such as a short-circuit current flows to a contact device 1, it is possible to stabilize the connection state between the movable contacts 81 and 82 and the fixed contacts 311 and 321.

Moreover, in the contact device 1 according to the present embodiment, the bus bar 22 has the electrical path segment 225 extending along the tangent line direction of the part 141 in the circumferential direction of the excitation coil 14 as viewed from one side (from above) in an axial direction of the excitation coil 14. Here, the orientation of the current I1 flowing through the electrical path segment 225 is the same as the orientation of the current I2 flowing through the part 141 in the circumferential direction of the excitation coil 14 when the excitation coil 14 is energized. A magnetic flux φ21 generated by the current I1 flowing through the electrical path segment 225 thus acts on the movable element 13 of the electromagnetic device 10 in the same orientation as a magnetic flux φ22 caused by the current I2 flowing through the excitation coil 14 (see FIGS. 9A and 9B). That is, the magnetic flux φ21 generated by the current I1 flowing through the electrical path segment 225 applies, to the movable element 13, force that maintains the movable element 13 in the excitation location in a similar manner to force (magnetic force) generated at the excitation coil 14 when the excitation coil 14 is energized. Thus, in the normally-off electromagnetic relay 100, a magnetic field generated by a current flowing through the electrical path segment 225 when the contact device 1 is in a closed state applies, to the movable element 13, force oriented such that the movable element 13 is maintained at the excitation location.

In the present embodiment, a magnetic flux φ 22 generated by the current I2 flowing through the excitation coil 14 passes upwardly through the movable element 13 and the stator 12 to generate magnetic attraction force between the movable element 13 and the stator 12. A magnetic flux φ 21 generated by the current I1 flowing through the electrical path segment 225 also passes upwardly through the movable element 13 and the stator 12, thereby generating magnetic attraction force between the movable element 13 and the stator 12. Thus, the magnetic flux φ21 generated by the current I1 flowing through the electrical path segment 225 generates assist force, and assist driving force by the electromagnetic device 10 to switch the contact device 1 from the open state to the closed state with the assist force. As used herein, the “assist force” means force applied to the movable element 13 by the magnetic field generated by the current I1 flowing through the electrical path segment 225.

As a result, the assist force increases force for attracting the movable element 13 to the stator 12, that is, force for pressing the movable element 13 against the stator 12. The magnetic flux φ21 generated by a current flowing through the electrical path segment 225 when the contact device 1 is in the closed state applies, to the movable element 13, force oriented such that the movable element 13 is maintained at the location (excitation location in the present embodiment) where the contact device 1 is in the closed state. The bus bar 22 and the electromagnetic device 10 are disposed in such a positional relationship.

Moreover, in the present embodiment, a direction (right and left direction) in which the electrical path segment 225 extends is orthogonal to the travel direction (upward and downward direction) of the movable element 13. Thus, the assist force generated by the current I1 flowing through the electrical path segment 225 efficiently acts in the travel direction of the movable element 13.

This can improve the force for maintaining the movable element 13 at the location where the contact device 1 is in the closed state. For example, when an anomalous electric current such as a short-circuit current flows to the contact device 1, the assist force becomes particularly large. Therefore, the movable element 13 can be stably maintained at the location (excitation location in the present embodiment) where the contact device 1 is in the closed state.

Moreover, in the present embodiment, the thickness direction (forward and rearward direction) of the electrical path segments 213 and 223 is orthogonal to the travel direction (upward and downward direction) of the movable contactor 8. This enables a relatively short distance between the center point of the electrical path segment 213 (or 223) and the center point of the movable contactor 8 in the cross section orthogonal to the longitudinal direction of the electrical path segments 213 and 223 (see FIG. 4A). As a comparative example, when the thickness direction of an electrical path segment is parallel to the travel direction of a movable contactor 8, the distance between a center point of the electrical path segment and a center point of the movable contactor 8 in a cross section orthogonal to the longitudinal direction of the electrical path segment is longer than that in the embodiment. Therefore, in the contact device 1 according to the present embodiment, repulsion force F1 greater than the repulsion force generated between the electrical path segment and the movable contactor 8 of the comparative example can be generated between the movable contactor 8 and the electrical path segments 213 and 223.

As a result, also as compared to the comparative example, it is possible to further stabilize the connection state of the movable contacts 81 and 82 to the fixed contacts 311 and 321 when an anomalous electric current such as a short-circuit current flows to a contact device 1.

Similarly, in the present embodiment, the thickness direction (forward and rearward direction) of the electrical path segment 255 is orthogonal to the travel direction (upward and downward direction) of the movable contactor 8. This enables a relatively short distance between the center point of electrical path segment 225 and the excitation coil 14 in a cross section orthogonal to the longitudinal direction of the electrical path segment 225 (see FIG. 9A). Consequently, large assist force is generated as comparted to the comparative example. For example, when an anomalous electric current such as a short-circuit current flows to the contact device 1, the assist force becomes particularly large. Therefore, the movable element 13 can be further stably maintained at the location (excitation location in the present embodiment) where the contact device 1 is in the closed state.

Moreover, in the present embodiment, the first yoke 6 and the second yoke 7 are also measures against electromagnetic repulsion force.

That is, as shown in FIG. 4B, when the current I flows through the movable contactor 8 rightward (toward the fixed terminal 32 when viewed from the fixed terminal 31), the magnetic flux φ1 is generated anticlockwise around the movable contactor 8 when viewed from the right. At this time, as described above, the front end 61 of the first yoke 6 and the tip surface of the projection 73 serve as N-poles, and the rear end 62 of the first yoke 6 and the tip surface of the projection 72 serve as S-poles, and thereby, attraction force acts between the first yoke 6 and the second yoke 7.

The first yoke 6 is fixed to the tip end (upper end) of the shaft 15, and therefore, when the movable element 13 is in the excitation location, the attraction force attracts the second yoke 7 upward. The upward attraction of the second yoke 7 applies upward force to the movable contactor 8 from the second yoke 7, thereby increasing the force of pushing the movable contactor 8 upward, that is, the force of pushing the movable contacts 81 and 82 against the fixed contacts 311 and 321.

Therefore, in the contact device 1 according to the present embodiment, the first yoke 6 and the second yoke 7 are provided, and thus, even when an anomalous electric current such as a short-circuit current flows to the contact device 1, it is possible to stabilize the connection state of the movable contacts 81 and 82 to the fixed contacts 311 and 321.

### (4) Electric Apparatus

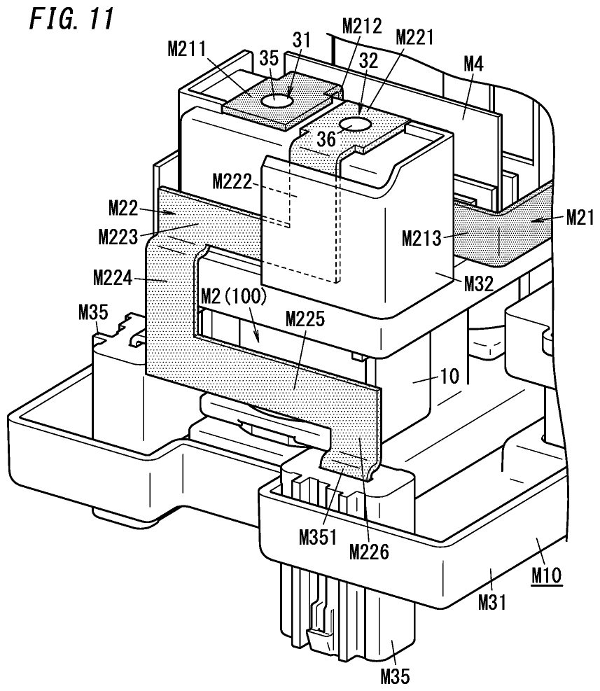

Next, a configuration of an electric apparatus M1 will be described with reference to FIGS. 10A to 11.

The electric apparatus M1 according to the present embodiment includes the two inner devices M2 and the housing M3. The inner devices M2 are electromagnetic relays 100 (the contact device 1 and the electromagnetic device 10) having the above-described configuration. The electric apparatus M1 is further provided with conductive bars M21 and M22 as “conductive members” instead of the above-described bus bars 21 and 22. The electric apparatus case M10 includes the housing M3 and the conductive bars M21 and M22.

The housing M3 is made of a synthetic resin which is electrically insulating. In the present embodiment, the housing M3 includes a base M31, an inner cover M32, and an outer cover M33.

The outer cover M33 has a lower surface having an opening. The base M31 is mechanically connected to the outer cover M33 so as to close a lower surface of the outer cover M33, thereby forming a box-like external contour containing the inner device M2 (here, the electromagnetic relay 100) in an interior together with the outer cover M33. The mechanical connection between the base M31 and the outer cover M33 is realized, for example, by welding or bonding.

The inner cover M32 is mounted on the inner device M2 so as to cover at least part of the inner device M2 between the base M31 and the outer cover M33. The inner cover M32 has a lower surface having an opening. The inner cover M32 is placed over the inner device M2 from above so as to cover part corresponding to the contact device 1 of the inner device M2. The inner cover M32 has an upper surface in which an opening pore is formed, and the opening pore allows the fixed terminals 31 and 32 of the inner device M2 to pass therethrough. The opening pore has a round shape and penetrates an upper wall of the inner cover M32 in the thickness direction (upward and downward direction). In the present embodiment, one inner cover M32 is mounted across two inner devices M2 (electromagnetic relays 100). Thus, one housing M3 holds two inner devices M2 constituted by the electromagnetic relays 100.

The housing M3 further includes a plurality of fixing parts M34 and a plurality of connectors M35. The electric apparatus M1 is attached to an attachment target by the plurality of fixing parts M34. The electric apparatus M1 is electrically connected to a connection target via the plurality of connectors M35. Since it is assumed in the present embodiment that the electromagnetic relay 100 is mounted on an electric vehicle, the electric apparatus M1 is fixed to a vehicle body (frame or the like) of the electric vehicle as the attachment target by the plurality of fixing parts M34. Moreover, the electric apparatus M1 is electrically connected to a battery and a load (e.g., an inverter) for driving as the connection targets via the plurality of connectors M35. Here, the plurality of fixing parts M34 are integrally formed with the outer cover M33 so as to project laterally from the outer cover M33. The plurality of connectors M35 are integrally formed with the base M31 so as to penetrate the base M31 in the upward and downward direction. The connectors M35 are integrated with the housing M3, but the configuration of the connectors M35 is not limited to this example. The connectors M35 may be separate from the housing M3 and may be held by the housing M3.

In the electric apparatus M1, as shown in FIG. 11, the conductive bars M21 and M22 as conductive members are held by the housing M3. The conductive bars M21 and M22 respectively correspond to the above-described bus bars 21 and 22. That is, the conductive bar M21 includes electrical path segments M211, M212, and M213 respectively corresponding to the electrical path segments 211, 212, and 213 of the bus bar 21. Moreover, the conductive bar M22 includes electrical path segments M221, M222, M223, M224, and M225 respectively corresponding to the electrical path segments 221, 222, 223, 224, and 225 of the bus bar 22.

Here, parts of the electrical path segments M21 and M22 are press fit to the housing M3, and thereby, the conductive bars M21 and M22 are held by the housing M3. Specifically, lower ends of the electrical path segment M212 and M222 are press fit to the inner cover M32, and thereby, the conductive bars M21 and M22 are held by the inner cover M32. However, the structure of holding the conductive bars M21 and M22 by the housing M3 is not limited to the press fit. For example, the conductive bars M21 and M22 may be held by the housing M3 by insert-molding the housing M3 using the conductive bars M21 and M22 as inserts. Alternatively, for example, the conductive bars M21 and M22 may be held by the housing M3 by fixing the conductive bars M21 and M22 to the housing M3 by screwing, swaging, bonding, or the like.

The conductive bar M22 further includes an electrical path segment M226. The electrical path segment M226 is connected to the electrical path segment M225 and is disposed in front of the inner device M2 so as to extend downward from the right end of the electrical path segment M225. A tip end (lower end) of the electrical path segment M226 is mechanically connected (coupled) to a contact M351 of the connector M35. Here, the contact M351 is formed integrally with the electrical path segment M226. Thus, in a state where the connector M35 is electrically connected to the load as the connection target, the conductive bar M22 is electrically connected to the load via the connector M35. A thickness direction (forward and rearward direction) of the electrical path segment M226 is orthogonal to the travel direction (upward and downward direction) of the movable contactor 8.

In FIG. 11, a specific shape of only the conductive bar M22 of the conductive bars M21 and M22 is shown. However, similarly to the conductive bar M22, the conductive bar M21 also includes an electrical path segment that connects the electrical path segment M213 to the connector M35.

Thus, in the electric apparatus M1, when an anomalous electric current such as a short-circuit current flows to the contact device 1 of the inner device M2, repulsion force is generated between the electrical path segment M213 of the conductive bar M21 and the movable contactor 8 and between the electrical path segment M223 of the conductive bar M22 and the movable contactor 8. Moreover, in the electric apparatus M1, when an anomalous electric current such as a short-circuit current flows to the contact device 1 of the inner device M2, a current flowing through the electrical path segment M225 of the conductive bar M22 generates assist force.

Here, the conductive bars M21 and M22 have rigidity similarly to the bus bars 21 and 22. Therefore, one end (electrical path segment 211) in the longitudinal direction of the conductive bar M21 is mechanically connected to the fixed terminal 31 to achieve a state where the entirety of the conductive bar M21 is supported by the fixed terminal 31, and one end (electrical path segment 221) in the longitudinal direction of the conductive bar M22 is mechanically connected to the fixed terminal 32 to achieve a state where the entirety of the conductive bar M22 is supported by the fixed terminal 32. Moreover, the other ends in longitudinal direction of the conductive bars M21 and M22 are mechanically connected to the connector M35. Thus, the conductive bars M21 and M22 are held by the housing M3 directly or indirectly via the inner device M2 (electromagnetic relay 100) in a state where the conductive bar M21 extends between the fixed terminal 31 and the connector M35, and the conductive bar M22 extends between the fixed terminal 32 and the connector M35.

Moreover, the electric apparatus M1 further includes a shield M4. The shield M4 is made of a magnetic material (ferromagnetic body) and has a function of shielding a magnetic flux between two inner devices M2 (electromagnetic relays 100). In the electric apparatus M1 according to the present embodiment, he two inner devices M2 are disposed back-to-back in a direction (forward and rearward direction) orthogonal to a direction (right and left direction) in which the pair of fixed terminals 31 and 32 are aligned as viewed from above. That is, the two inner devices M2 are positioned in the housing M3 such that a rear surface of one of the inner devices M2 faces a rear surface of the other of the inner devices M2. The shield M4 has a rectangular plate shape and is disposed between the rear surfaces of the two inner devices M2. The shield M4 is held by the inner cover M32. Thus, it is possible to reduce the influence of the magnetic flux, which is generated by the current flowing through the conductive bar M21 electrically connected to the one inner device M2, on the other inner device M2.

In addition to the electromagnetic relay 100 as the inner device M2, the electric apparatus M1 may include various types of sensors. The sensor is a sensor for measuring, for example, a current flowing through the inner device M2 or the conductive bars M21 and M22; or a temperature in an internal space of the inner device M2 or the housing M3.

### (5) Variation

Variations of the first embodiment will be described below. Components similar to those in the first embodiment are denoted by the same reference signs as those in the first embodiment, and the description thereof is accordingly omitted.

(5.1) First Variation

The configuration of the electric apparatus M1 according to the first embodiment, in particular, the configurations of the housing M3 and the conductive bars M21 and M22 are mere examples and may accordingly be modified.

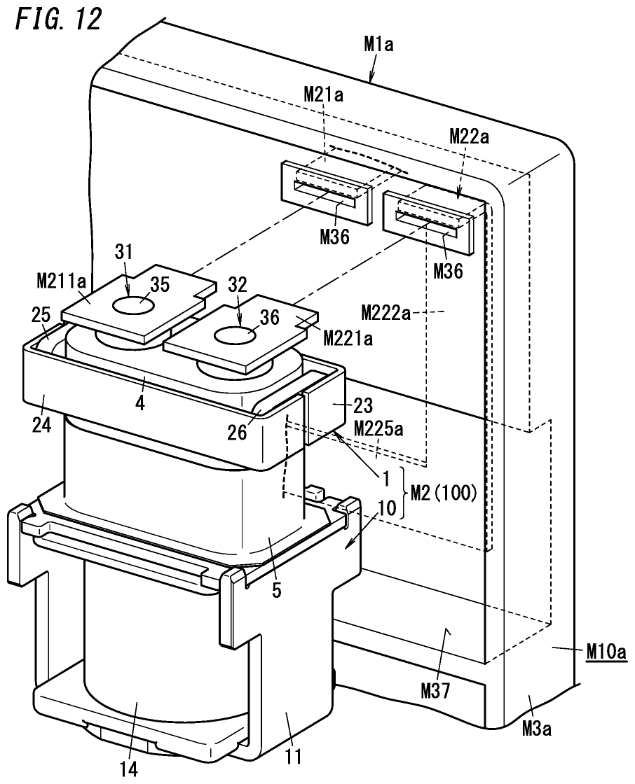

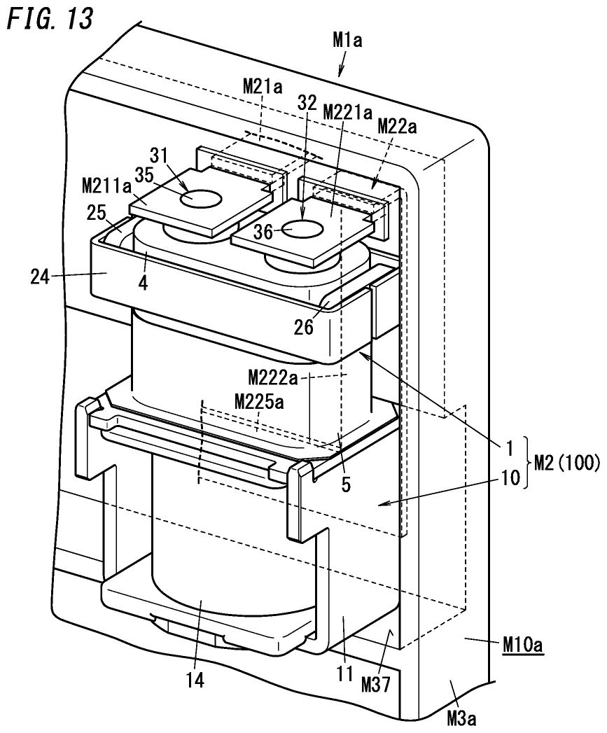

As illustrated in FIGS. 12 and 13, an electric apparatus M1a relating to the first variation of the first embodiment is different from the electric apparatus M1 according to the first embodiment in the configuration of a housing M3a. Moreover, in accordance with the configuration of the housing M3a, the configuration of the conductive bars M21 and M22 in the electric apparatus M1a according to the first variation is different from that in the electric apparatus M1 of the first embodiment. A case M10a for the electric apparatus according to the present variation includes the housing M3a and conductive bars M21a and M22a.

In the present variation, the housing M3a is formed in the form of a flat rectangular parallelepiped in the forward and rearward direction. The housing M3 has a front surface having a pair of terminal ports M36 and a recess M37. The pair of terminal ports M36 are formed in locations facing swage sections 35 and 36 in the forward and rearward direction. The recess M37 is formed at a location facing an electromagnetic device 10 in the forward and rearward direction. The recess M37 forms a space for avoiding interference between the housing M3a and the electromagnetic device 10 by accommodating part of the electromagnetic device 10 in a state where an inner device M2 is held by the housing M3a as shown in FIG. 13.

The conductive bar M21a includes an electrical path segment M211a corresponding to the electrical path segment 211 of the bus bar 21. Moreover, the conductive bar M22a includes electrical path segments M221a, M222a, and M225a respectively corresponding to the electrical path segments 221, 222, and 225 of the bus bar 22. In FIGS. 12 and 13, electrical path segments of the conductive bar M21a which correspond to the electrical path segments 212 and 213 of the bus bar 21 are omitted. Here, the conductive bars M21a and M22a are physically separated into electrical path segments M211a and M221a which are mechanically connected respectively to fixed terminals 31 and 32 and electrical path segments other than the electrical path segments M211a and M221a. That is, the electrical path segment M221a of the conductive bar M22a is separated from the electrical path segments M222a and M225a. Of the conductive bars M21a and M22a, electrical path segments (e.g., the electrical path segments M222a and M225a) other than the electrical path segments M211a and M221a are embedded in the housing M3a, and are held by the housing M3a by a coupling structure such as swaging.

In the present variation, as shown in FIG. 13, the inner device M2 is held by the housing M3a in a state where parts of the electrical path segments M211a and M221a are inserted into the pair of terminal ports M36. As a result, the electrical path segments M211a and M221a come into contact with the electrical path segments (e.g., electrical path segments M222a and M225a) other than the electrical path segments M211a and M221a of the conductive bars M21a and M22a through the terminal ports M36. Therefore, the electrical path segment M221a of the conductive bar M22a is electrically connected to the electrical path segments M222a and M225a. That is, in the present variation, simply inserting the parts of the electrical path segments M211a and M221a into the pair of terminal ports M36 completes electrical connection of the inner device M2 to the conductive bars M21a and M22a held by the housing M3a. Here, of the conductive bars M21a and M22a, the parts located in the pair of terminal ports M36 correspond to contacts of connectors. In other words, the electric apparatus M1a further includes connectors disposed in the housing M3a, and in a state where the inner device M2 is held by the housing M3a, fixed contacts 311 and 321 are electrically connected to the conductive bars M21a and M22a via the contacts.

(5.2) Second Variation

The shape of the bus bar is not limited to the shape of the bus bars 21 and 22 shown in the first embodiment.

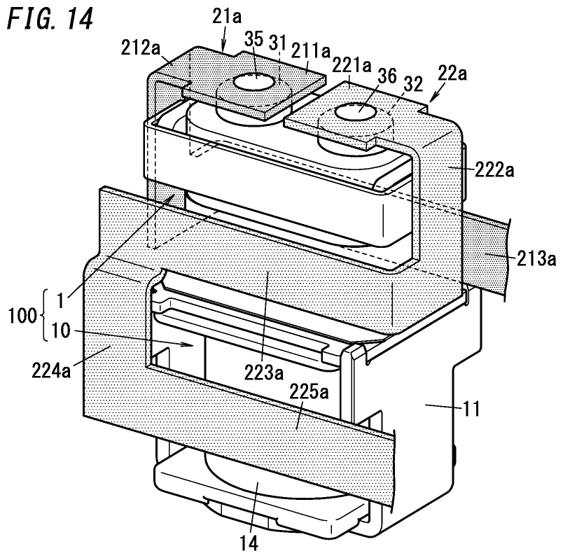

A contact device 1 may include bus bars 21a and 22a shown in FIG. 14 in place of the bus bars 21 and 22.

The bus bar 21a of the present variation includes three electrical path segments 211a, 212a, and 213a. The arrangement of the electrical path segment 212a differs from that of the electrical path segment 212 in the first embodiment. The bus bar 22a of the present variation includes five electrical path segments 221a, 222a, 223a, 224a, and 225a. The arrangement of the electrical path segment 222a differs from that of the electrical path segment 222 in the first embodiment. That is, in the present variation, the electrical path segments 212a and 222a are disposed on respective sides in the right and left direction with respect to a pair of fixed terminals 31 and 32. In sum, the electrical path segment 212a (extension piece) is coupled to the electrical path segment 211a and is disposed to extend downward from a left end of the electrical path segment 211a. The electrical path segment 212a is disposed on a straight line connecting the fixed terminal 31 to the fixed terminal 32.

Also in the contact device 1 according to the present variation, the orientation of a current I flowing through the electrical path segment 212a is opposite to the orientation of a current I flowing through the fixed terminal 31. Similarly, the orientation of a current flowing through the electrical path segment 222a is opposite to the orientation of a current I flowing through the fixed terminal 32.

(5.3) Third Variation

In the first embodiment, the force for pushing up the fixed contacts 311 and 321 by the movable contactor 8 is increased by using the two bus bars 21 and 22, but but this should not be construed as limiting.

In a contact device 1, at least one of the bus bar 21 or 22 is adopted. That is, in the contact device 1, at least one of the bus bar 21 or 22 is adopted.

When one of the bus bar 21 or 22 is adopted, the shape of the bus bar may be the above-described shape or another shape.

The present variation adopts a bus bar 22b whose shape is different from the shape of the bus bars 21 and 22.

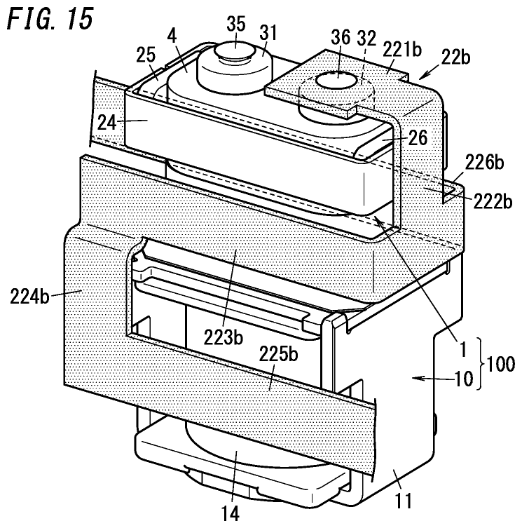

The bus bar 22b includes six electrical path segments 221b, 222b, 223b, 224b, 225b, and 226b as shown in FIG. 15. The bus bar 22b primarily differs from the bus bar 22 in first embodiment in that the bus bar 22b further includes the electrical path segment 226b. The electrical path segment 222b is the same as the electrical path segment 222a of the second variation and will therefore not be described here. The electrical path segment 226b is connected to the electrical path segment 222b and is disposed behind a housing 4 so as to extend leftward (toward a fixed terminal 31 as viewed from a fixed terminal 32) from a lower end of the electrical path segment 222b. The thickness direction (forward and rearward direction) of the electrical path segment 226b is orthogonal to the travel direction (upward and downward direction) of a movable contactor 8.

In the present variation, when the movable contactor 8 is located in the closed position, the movable contactor 8 is located between the electrical path 226b and fixed contacts 311 and 321 as viewed in one of the forward and rearward directions. In order to achieve such a positional relationship, the electrical path segment 226b is disposed on an outer side of the housing 4 to be substantially parallel to the movable contactor 8. An end of the electrical path segment 226b opposite from the electrical path segment 222b is, together with the electrical path segment 225b, electrically connected to, for example, a load.

In a cross section orthogonal to the right and left direction of the contact device 1 of present variation, an angle between a straight line connecting a center point of the electrical path segment 226b and a center point of the movable contactor 8 and a straight line along the forward and rearward direction is 45 degrees. That is, the electrical path segment 226b is disposed at a location corresponding to the electrical path segment 213 (see FIG. 4A) in the first embodiment. This value (45 degrees) is one example, and the angle is not limited to this value.

Moreover, the length of the electrical path segment 226b is greater than or equal to a distance L11 (see FIGS. 7A and 7B) between a movable contact 81 and movable contact 82.

In the present variation, for example, a current flowing through the movable contactor 8 from the fixed terminal 31 toward the fixed terminal 32 flows from the electrical path segment 222b into the electrical path segments 223b and 226b and is diverted to the electrical path segment 223b and the electrical path segment 226b. Thus, the orientation of a current I flowing through the electrical path segment 226b is opposite to the orientation of the current I flowing through the movable contactor 8 similar to the electrical path segment 223b.

The present variation may be combined with at least one of the first variation or the second variation.

(5.4) Fourth Variation

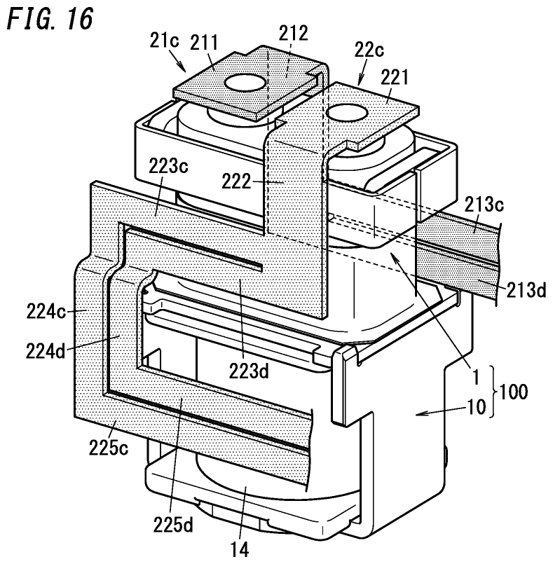

A contact device 1 may include bus bars 21c and 22c shown in FIG. 16 in place of the bus bars 21 and 22 in the first embodiment.

The bus bar 21c of the present variation has electrical path segments 213c and 213d in place of the electrical path segment 213 of the first embodiment. The bus bar 22c of the present variation has electrical path segments 223c and 223d in place of the electrical path segment 223, electrical path segments 224c and 224d in place of the electrical path segment 224, and electrical path segments 225c and 225d in place of the electrical path segment 225 of the first embodiment. Opposite ends of the electrical path segment 213c and 213d from an electrical path segments 212 are electrically connected to, for example, a battery for running. Opposite ends of the electrical path segment 225c and 225d from an electrical path segments 222 are electrically connected to, for example, a load.

That is, the bus bar 21c of the present variation includes four electrical path segments 211, 212, 213c, and 213d. Since the electrical path segments 211 and 212 have been described above, the description thereof is omitted here. The electrical path segments 213c and 213d correspond to a configuration obtained by dividing an electrical path segment 213 into two pieces in a short direction (upward and downward direction). Thus, similar to the electrical path segment 213 in the first embodiment, the electrical path segments 213c and 213d are located such that when the movable contactor 8 is located in the closed position, the movable contactor 8 is located between the electrical path segments 213c and 213d and the fixed contacts 311 and 321 when viewed in one of the forward and rearward directions.

The bus bar 22c of the present variation includes eight electrical path segments 221, 222, 223c, 223d, 224c, 224d, 225c, and 225d. Since the electrical path segments 221 and 222 have been described above, the description thereof is omitted here. The electrical path segments 223 c and 223d, the electrical path segments 224c and 224d, and the electrical path segments 225c and 225d correspond to configurations obtained by dividing the electrical path segments 223, 224, and 225 into two pieces in short direction, respectively. Thus, similar to the electrical path segment 225 in the first aspect, the electrical path segments 225c and 225d extend along tangent line direction D1 of a part 141 in a circumferential direction of the excitation coil 14, as seen from one side (above) in the axial direction of the excitation coil 14 (see FIG. 9A).

The present variation may be combined with at least one of the first to third variations.

(5.5) Fifth Variation

The first embodiment has the configuration in which the first yoke 6 is fixed to the tip end (upper end) of the shaft 15, that is, the first yoke 6 is configured to be movable along the same direction as the travel direction of the movable contactor 8, but this should not be construed as limiting.

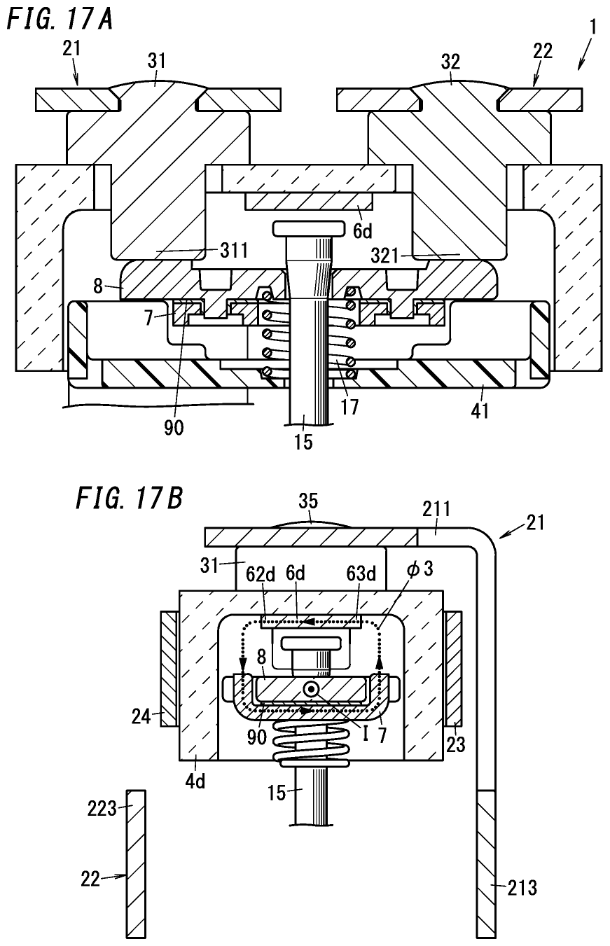

The first yoke 6 may be provided such that the location of the first yoke 6 relative to the housing 4 is fixed. For example, a contact device 1 may include a first yoke 6d shown in FIGS. 17A and 17B in place of the first yoke 6.

The first yoke 6d is fixed to part of an inner peripheral surface of a housing 4. Here, the first yoke 6d is fixed to a location above a movable contactor 8 and opposite to the movable contactor 8. As shown in FIG. 17B, when a current I flows through the movable contactor 8 rightward (toward a fixed terminal 32 when viewed from a fixed terminal 31), a magnetic flux φ3 generated anticlockwise around the movable contactor 8 when viewed from the right (see FIG. 17B). Due to generation of the magnetic flux φ3, the first yoke 6d and a second 7 are attracted to each other in a similar manner to the first yoke 6 and the second yoke 7 being attracted to each other.

Alternatively, the first yoke 6d may be fixed to an outer peripheral surface of the housing 4. Alternatively, the first yoke 6d may be fixed to the fixed terminals 31 and 32 in the housing 4.

The present variation may be combined with at least one of the first to fourth variations.

(5.6) Sixth Variation

In the contact device 1 according to the first embodiment, the capsule yoke 23 is provided between the housing 4 and the electrical path segment 212 of the bus bar 21, and the yoke 24 is provided between the housing 4 and the electrical path segment 222 of the bus bar 22, but this should not be construed as limiting.

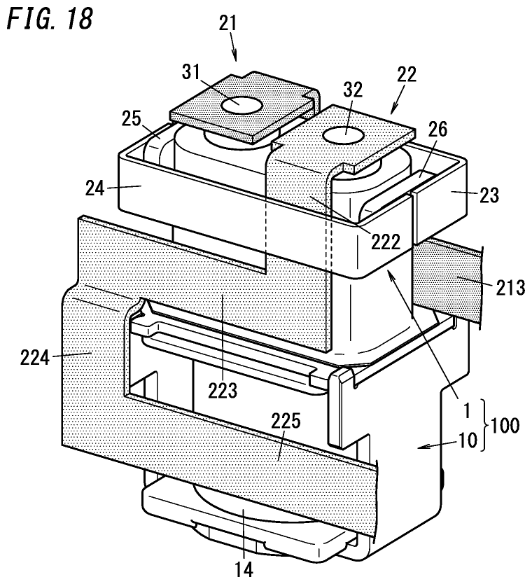

As shown in FIG. 18, in a contact device 1 according to the present variation, an electrical path segment 212 of a bus bar 21 is located between a capsule yoke 23 and a housing 4 when viewed from above (in one of travel directions of a movable contactor 8). Similarly, an electrical path segment 222 of a bus bar 22 is located between a capsule yoke 24 and the housing 4 when viewed from above. Moreover, an electrical path segment 213 is also located between the capsule yoke 23 and the housing 4 when viewed from above. Moreover, an electrical path segment 223 is also located between the capsule yoke 23 and the housing 4 when viewed from above.

In the configuration of the present variation, the electrical path segments 213 and 223 can be brought closer to the capsule yoke 8 than when the electrical path segment 212 is outside the capsule yoke 23 and the electrical path segment 222 is outside the capsule yoke 24, and therefore, further large repulsion force can be generated. Thus, the contact device 1 according to the sixth variation shown in FIG. 18 enables the force to push up the movable contactor 8 upward, that is, the force to push movable contacts 81 and 82 to the fixed contacts 311 and 321 to be increased.

(5.7) Seventh Variation

In the contact device 1 according to the first embodiment, the electrical path segment 225 extends straight along the right and left direction, but this should not be construed as limiting.

The present variation adopts a bus bar 22e or a bus bar 22f which differ from the bus bar 22 in shape.

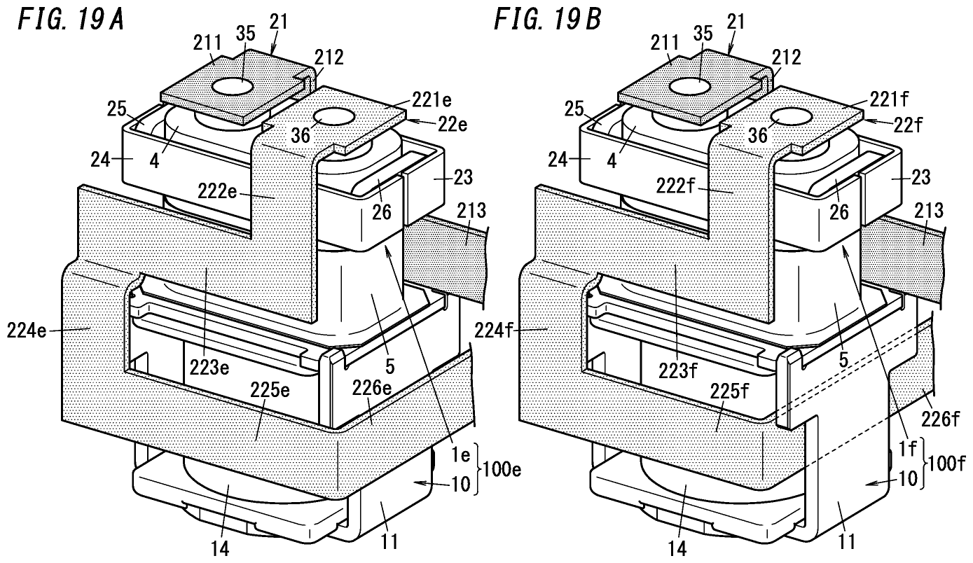

First, in a contact device 1e (and an electromagnetic relay 100e) shown in FIG. 19A, the bus bar 22e includes six electrical path segments 221e, 222e, 223e, 224e, 225e, and 226e. The bus bar 22e is different from the bus bar 22 of the first embodiment primarily in that the bus bar 22e further includes the electrical path segment 226e. The electrical path segment 226e is connected to the electrical path segment 225e and is disposed to the right of an electromagnetic device 10 (excitation coil 14) so as to extend rearward from a right end of the electrical path segment 225e. The thickness direction (right and left direction) of the electrical path segment 226e is orthogonal to the travel direction (upward and downward direction) of a movable contactor 8. In this configuration, from both the electrical path segment 225e disposed in front of the excitation coil 14 and the electrical path segment 226e disposed to the right of the excitation coil 14, assist force can be applied on a movable element 13, and further large assist force can be generated. Thus, the contact device 1e enables the force that attracts the movable element 13 to a stator 12, that is, force that presses the movable element 13 against the stator 12 to further be increased.

Moreover, in a contact device if (and an electromagnetic relay 1000 shown in FIG. 19B, the bus bar 22f includes six electrical path segments 221f, 222f, 223f, 224f, 225f, and 226f. In this example, the electrical path segment 226f, which corresponds to the electrical path segment 226e in FIG. 19A, is located between a yoke 11 and the excitation coil 14. That is, the electrical path segment 226f is disposed closer to the excitation coil 14 by being positioned on an inner side but not on an outer side of the yoke 11. This configuration enables large assist force to be generated at the electrical path segment 226f as compared to the contact device if shown in FIG. 19A. Thus, the contact device if enables the force that attracts the movable element 13 to a stator 12, that is, force that presses the movable element 13 to the stator 12 to be increased.

The present variation may be combined with at least one of the first to sixth variations.

(5.8) Eighth Variation

In the contact device 1 according to the first embodiment, the electrical path segment 225 that generates the assist force is located in front of the excitation coil 14, but this should not be construed as limiting.

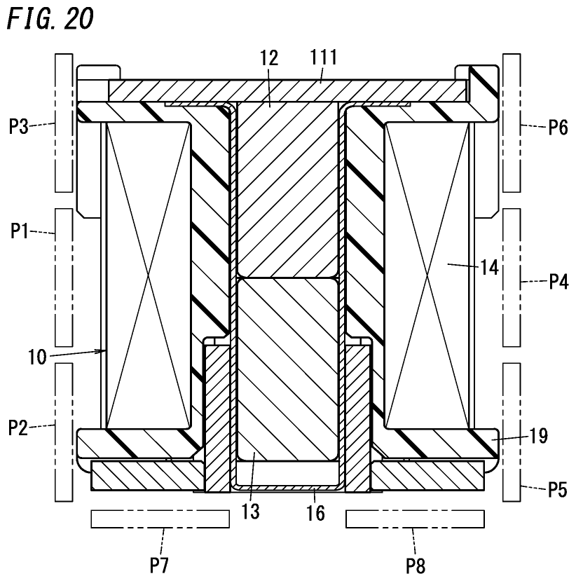

For example, an electrical path segment 225 for generating assist force may be disposed at a location indicated by any of locations P1 to P8 in FIG. 20. FIG. 20 is a conceptual view illustrating the electrical path segment 225 in a cross section similar to that in FIG. 9A. In FIG. 20, the locations P1 to P8 indicate locations as candidates in which the electrical path segment 225 is to be disposed by a virtual line (long dashed double-short dashed line).

In the first embodiment, the electrical path segment 225 is disposed at the location P1 of the locations P1 to P8. Here, in the upward and downward direction, a center point of the electrical path segment 225 is located on the interface between a stator 12 and a movable element 13 when the movable element 13 is in the excitation location. In contrast, even when the electrical path segment 225 is disposed at the location P2 or the location P3 located under or over the location P1, assist force is generated by the electrical path segment 225. The assist force generated in the electrical path segment 225 is the largest when the electrical path segment 225 is disposed at the location P1 of the locations P1 to P3.

Also when the electrical path segment 225 is disposed in any of the locations P4 to P6 behind an excitation coil 14, the assist force is generated by the electrical path segment 225. Also when the electrical path segment 225 is disposed at the locations P7 or P8 under the excitation coil 14, the assist force is generated by the electrical path segment 225. However, at a location directly under the movable element 13 of a location below the excitation coil 14, a magnetic flux generated by a current flowing through the electrical path segment 225 does not act as the assist force on the movable element 13.

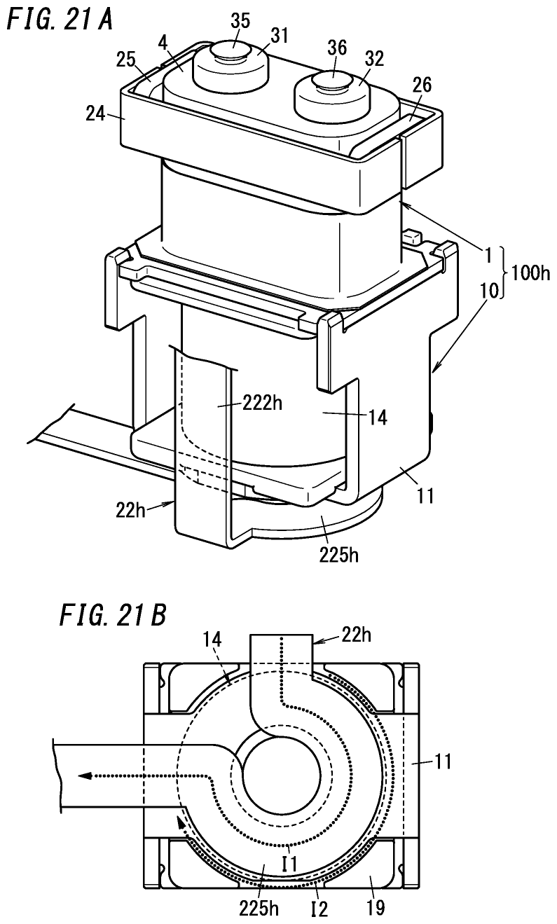

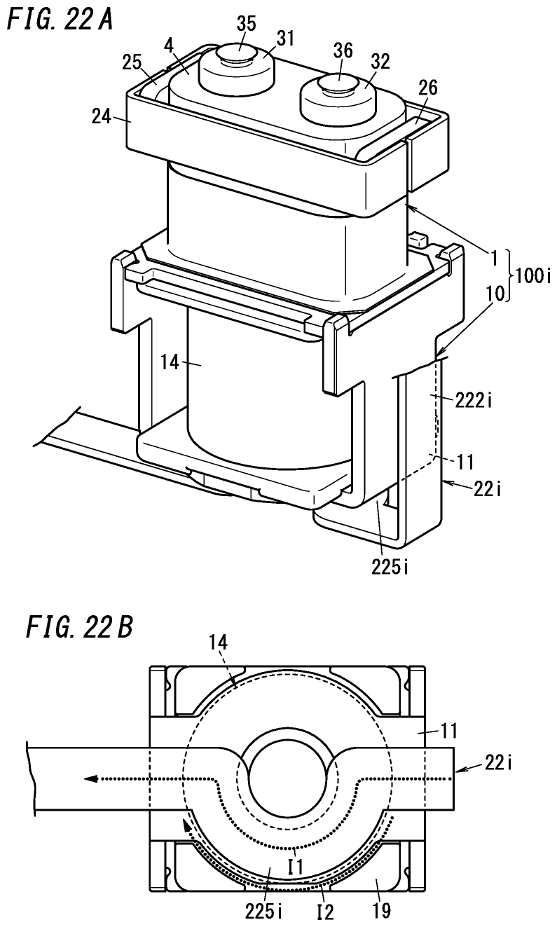

A specific example when the electrical path segment 225 is disposed below the excitation coil 14 will be described with reference to FIGS. 21A to 22B.

In an electromagnetic relay 100h shown in FIGS. 21A and 21B, a bus bar 22h includes an electrical path segment 222h (extension piece) extending along the upward and downward direction and an electrical path segment 225h. An upper end side of the electrical path segment 222h is connected to a fixed terminal 32. The electrical path segment 225h is coupled to a lower end of the electrical path segment 222h and is disposed under an excitation coil 14 in an electromagnetic device 10. As shown in FIG. 21B, the electrical path segment 225h has a (arc-like) shape that forms part of a circumference centering the central axis of the excitation coil 14 when the electromagnetic relay 100h is viewed from below. That is, the electrical path segment 225h is formed in an arc-like shape along an outer periphery of the excitation coil 14 when the electromagnetic relay 100h is viewed from below. In particular, in the electromagnetic relay 100h, the electrical path segment 225h is formed so as to draw an arc around the central axis of the excitation coil 14 over ¾ of the circumference (i.e., 270 degrees).

Here, it is assumed that a current I1 flows through a movable contactor 8 from a fixed terminal 31 toward the fixed terminal 32. At this time, the current I1 flows from the fixed terminal 32 to the electrical path segment 222h and the electrical path segment 225h in this order. Therefore, as shown in FIG. 21B, the current I1 flows clockwise through the electrical path segment 225h as viewed from below. Here, it is assumed that a current I2 flows clockwise through the excitation coil 14 as viewed from below. Then, when the excitation coil 14 is energized, the current I2 flows through a portion of the excitation coil 14 facing the electrical path segment 225h (lower surface of the excitation coil 14) in an orientation the same as the orientation of the current I1 flowing through the electrical path segment 225h. A magnetic flux generated by the current I1 flowing through the electrical path segment 225h thus acts on a movable element 13 of the electromagnetic device 10 in an orientation the same as the orientation of a magnetic flux generated by the current I2 flowing through the excitation coil 14. Thus, the magnetic flux generated by the current I1 flowing through the electrical path segment 225h generates assist force, and when the contact device 1 is in the closed state in the normally-off type electromagnetic relay 100h, the assist force assists with force oriented such that the movable element 13 is maintained at the excitation location.

In an electromagnetic relay 100i shown in FIGS. 22A and 22B, a bus bar 22i includes an electrical path segment 222i (extension piece) extending along the upward and downward direction and an electrical path segment 225i. An upper end side of the electrical path segment 222i is connected to a fixed terminal 32. The electrical path segment 225i is coupled to a lower end of the electrical path segment 222i and is positioned under an excitation coil 14 in an electromagnetic device 10. As shown in FIG. 22B, the electrical path segment 225i has a shape (arc-like shape) that forms part of a circumference whose center corresponds to a central axis of the excitation coil 14 when the electromagnetic relay 100i is viewed from below. That is, the electrical path segment 225i is formed in an arc-like shape along an outer periphery of the excitation coil 14 when the electromagnetic relay 100i is viewed from below. In particular, in the electromagnetic relay 100i, the electrical path segment 225i is formed so as to draw an arc around the central axis of the excitation coil 14 over ½ of the circumference (i.e., 180 degrees).

Here, it is assumed that a current I1 flows through a movable contactor 8 from a fixed terminal 31 toward the fixed terminal 32. At this time, the current I1 flows from the fixed terminal 32 to the electrical path segment 222i and the electrical path segment 225i in this order. Therefore, as shown in FIG. 22B, the current I1 flows clockwise through the electrical path segment 225i as viewed from below. Here, it is assumed that the current I2 flows clockwise through the excitation coil 14 as viewed from below. Then, when the excitation coil 14 is energized, the current I2 flows through part of the excitation coil 14 facing the electrical path segment 225i (lower surface of the excitation coil 14) in an orientation the same as the orientation of the current I1 flowing through the electrical path segment 225i. A magnetic flux generated by the current I1 flowing through the electrical path segment 225i thus acts on a movable element 13 of the electromagnetic device 10 in an orientation the same as the orientation of a magnetic flux generated by the current I2 flowing through the excitation coil 14. Thus, the magnetic flux generated by the current I1 flowing through the electrical path segment 225i generates assist force, and when the contact device 1 is in the closed state in the normally-off type electromagnetic relay 100i, the assist force assists with force oriented such that the movable element 13 is maintained at the excitation location.

The present variation may be combined with at least one of the first to seventh variations.

### Second Embodiment

An electromagnetic relay 100g according to the present embodiment is different from that of the first embodiment in that the shape of bus bars 21g and 22g in the second embodiment differs from that in the first embodiment. The difference from first embodiment will be mainly described below. Components similar to those in the first embodiment are denoted by the same reference signs as those in the first embodiment, and the description thereof is accordingly omitted.

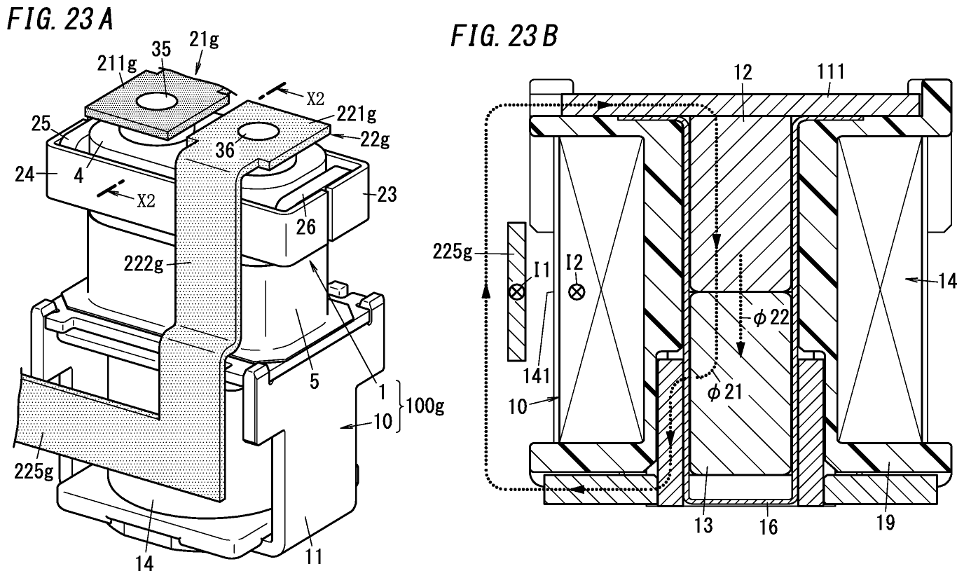

In the present embodiment, each of the bus bars 22g and 22g include neither a reverse direction electrical path segment that allows a current I to flow in an orientation opposite to the orientation of a current I flowing through a movable contactor 8 nor a forward direction electrical path segment that allows a current I to flow in an orientation the same as the orientation of the current I flowing through the movable contactor 8. That is, the bus bar 21g includes an electrical path segment 211g as illustrated in FIG. 23A and no electrical path segment corresponding to the electrical path segment 213 in the first embodiment. Moreover, the bus bar 22g includes three electrical path segments 221g, 222g, and 225g as shown in FIG. 23A and no electrical path segment corresponding to the electrical path segment 223 in the first embodiment. The electrical path segments 211g and 221g are respectively the same as the electrical path segments 211 and 221 in the first embodiment, and therefore, the description thereof is omitted here.

In the present embodiment, the electrical path segment 222g is coupled to the electrical path segment 221g and extends in the upward and downward direction from a front end of the electrical path segment 221g to an electromagnetic device 10. The electrical path segment 225g is connected to the electrical path segment 222g and is disposed in front of the electromagnetic device 10 so as to extend leftward (toward a fixed terminal 31 as viewed from a fixed terminal 32) from a lower end of the electrical path segment 222g. The arrangement of the electrical path segment 225g differs from that of the electrical path segment 225 in the first embodiment. Thus, similar to the electrical path segment 225 in the first aspect, the electrical path segment 225g extends along a tangent line direction of a part 141 (see FIG. 23B) in a circumferential direction of an excitation coil 14 as seen from one side (above) in an axial direction of the excitation coil 14. A thickness direction (forward and rearward direction) of the electrical path segment 225g is orthogonal to a travel direction (upward and downward direction) of the movable contactor 8.

Also in the electromagnetic relay 100g according to the present embodiment, as shown in FIG. 23B, the orientation of the current I1 flowing through the electrical path segment 225g is the same as the orientation of a current I2 flowing through the part 141 in the circumferential direction of the excitation coil 14 when the excitation coil 14 is energized. For example, it is assumed that the current I1 flows leftward (toward the fixed terminal 31 as viewed from the fixed terminal 32) through the electrical path segment 225g. In this case, it is assumed that the current I2 flows clockwise through the excitation coil 14 when viewed from above. Thus, the current I2 flows leftward (toward the fixed terminal 31 as viewed from the fixed terminal 32) through a portion of the excitation coil 14 facing the electrical path segment 225g (a front surface side of the excitation coil 14). FIG. 23B is a sectional view along X2-X2 of FIG. 23A and is a conceptual view, in which the contact device 1 is omitted.

Thus, a magnetic flux φ21 generated by the current I1 flowing through the electrical path segment 225g acts on a movable element 13 of the electromagnetic device 10 in an orientation the same as the orientation of a magnetic flux φ22 generated by the current I2 flowing through the excitation coil 14 (see FIG. 23B). That is, the magnetic flux φ21 generated by the current I1 flowing through the electrical path segment 225g applies, to the movable element 13, force that maintains the movable element 13 in the excitation location in a similar manner to the force (magnetic force) generated at the excitation coil 14 when the excitation coil 14 is energized. Thus, in the electromagnetic relay 100g, which is a normally-off electromagnetic relay, a magnetic field generated by the current flowing through the electrical path segment 225g when the contact device 1 is in a closed state applies, to the movable element 13, force oriented such that the movable element 13 is maintained in the excitation location.

(Additional Variation)

Other variations will be described below. Note that the variations described below are applicable accordingly in combination with the above-described embodiments (including variations of the embodiments).

In each embodiment, the housing 4 is configured to hold the fixed terminals 31 and 32 in a state where parts of the fixed terminals 31 and 32 are exposed, but this should not be construed as limiting. The housing 4 may accommodate the entirety of fixed the terminals 31 and 32 therein. That is, the housing 4 is at least configured to accommodate the fixed contacts 311 and 321 and the movable contactor 8.

In each embodiment, the contact device does not have to include the capsule yoke. When the capsule yoke is provided, the capsule yoke may reduce repulsion force between the movable contactor 8 and the electrical path segments 213 and 223. Thus, omitting the capsule yoke enables a reduction in repulsion force due to the capsule yoke to be suppressed and consequently enables force for pushing up the movable contactor 8 upward to be increased.

In each embodiment, the electromagnetic relay is a so-called normally-off electromagnetic relay in which the movable contactor 8 is located in the open position when the excitation coil 14 is de-energized, but the electromagnetic relay may be a normally-on electromagnetic relay. In the normally-on electromagnetic relay, a movable contactor 8 is located in the closed position when an excitation coil 14 is de-energized, and therefore, assist force as force oriented such that a movable element 13 is maintained in a non-excitation state acts on the movable 13.

In each embodiment, the movable contactor 8 holds two movable contacts but is not limited to this example. The movable contactor 8 may hold one movable contact or may hold three or more movable contacts. Similarly, the number of fixed terminals (and fixed contacts) is not limited to two but may be one or may be three or more.

The electromagnetic relay according to each embodiment is an electromagnetic relay without a holder but is not limited to this example. The electromagnetic relay may be an electromagnetic relay with a holder. Here, the holder has a rectangular cylindrical shape with both sides in the right and left direction being open and is combined with the movable contactor 8 such that the movable contactor 8 penetrates the holder in the right and left direction. The pressure spring 17 is placed between a lower wall of the holder and the movable contactor 8. That is, a center part of the movable contactor 8 in the right and left direction is held by the holder. The shaft 15 is fixed at its upper end to the holder. When the excitation coil 14 is energized, the shaft 15 is pushed upward, thereby moving the holder upward. Along with this movement, the movable contactor 8 moves upward such that the pair of movable contacts 81 and 82 are located at the closed position where the movable contacts 81 and 81 respectively come into contact with the pair of fixed contacts 311 and 321.

The contact device of each embodiment is a plunger-type contact device but may be a hinge-type contact device.

The bus bar of each embodiment is configured to be mechanically connected to the fixed terminals 31 and 32 by swaging to the fixed terminals 31 and 32, but the bus bar may be mechanically connected to the fixed terminals 31 and 32 by screwing. Alternatively, the bus bar may be welded or coupled to the fixed terminals 31 and 32 by brazing or the like.

The arc extinguishing magnet of each embodiment is disposed between an outer side of the housing 4 (that is, between the capsule yoke and the housing 4), but the arc extinguishing magnet is not limited to this configuration. The arc extinguishing magnet may be located on an inner side of the housing 4.

In the contact device of each embodiment, the yoke, the arc extinguishing magnet, and the capsule yoke are not essential configurations.

Each of the movable element 13 and the stator 12 is not limited to an iron core and may be made of a magnetic material or may have an iron core covered with a resin or the like.

The bus bar of each embodiment may include an electrical path segment which is located on the same side as the fixed contacts 311 and 321 or the fixed terminal 31 and 32 with respect to the movable contactor 8 in the travel direction of the movable contactor 8 when the movable contact or 8 is located in the closed position. The electrical path segment extends along the direction of the current I flowing through the movable contactor 8. This electrical path segment constitutes a forward direction electrical path segment that allows a current I to flow in an orientation the same as the orientation of the current I flowing through the movable contactor 8. According to such a configuration, attraction force is generated between the forward direction electrical path segment and the movable contactor 8 when an anomalous electric current such as a short-circuit current flows to the contact device. As used herein “attraction force” in the present disclosure refers to force in a mutually attracting orientation of a plurality of types of force interacting with each other between the movable contactor 8 and the forward direction electrical path segment. This increases force that pushes the movable contactor 8 upward, that is, force that pushes the movable contacts 81 and 82 against the fixed contacts 311 and 321. In other words, a magnetic field generated by the current I flowing through the bus bars (conductive members) located on an outer side of the housing 4 when the movable contactor 8 is located in the closed position applies, to the movable contactor 8, force oriented such that the movable contactor 8 is maintained in the closed position in the travel direction of the movable contactor 8. In this embodiment, an upward force component of the attraction force corresponds to the force oriented such that the movable contactor 8 is maintained in the closed position.

The bus bar of each embodiment includes neither a reverse direction electrical path segment that allows a current I to flow in an orientation opposite to the orientation of the current I flowing through a movable contactor 8 nor a forward direction electrical path segment that allows a current I to flow in an orientation the same as the orientation of the current I flowing through the movable contactor 8. Even in this configuration, the bus bar includes electrical path segment that generates assist force, which enables the improvement of the force for maintaining the movable element 13 at a location where the contact device is in the closed state.

Moreover, upper electrical path segments (electrical path segments 213 and 223) located on the same side (upper side) as the movable contactor 8 with respect to the excitation coil 14 may allow a current I to flow in an orientation the same as the orientation of the current I flowing through the movable contactor 8. That is, the orientation of the current I flowing through the electrical path segment 213 and the electrical path segment 223 may be the same as the orientation of the current I flowing through the movable contactor 8.

Moreover, the capsule yokes 23 and 24 and the arc extinguishing magnets 25 and 26 may be provided in the housing 4. At this time, the arc extinguishing magnet 25 is shielded from the fixed terminal 31, in particular, the fixed contact 311, and the arc extinguishing magnet 26 is shielded from the fixed terminal 32, in particular, the fixed contact 321.

Moreover, various configurations of each of the embodiments and variations are applicable in appropriate combinations with the electric apparatus M1 or M1a according to the first embodiment or the first variation of the first embodiment.

### SUMMARY

As described above, an electromagnetic relay (100, 100e, 100f, 100g, 100h, 100i) of a first aspect includes an electromagnet device (10), a contact device (1, 1e, 1f), and a bus bar (21, 22, 21a, 22a, 22b, 21c, 22c, 22e, 22f, 21g, 22g, 22h, 22i, 103 to 106). The electromagnetic device (10) includes an excitation coil (14), a stator (12), and a movable element (13). The electromagnetic device (10) is configured to: attract the movable element (13) to the stator (12) by a magnetic field generated at the excitation coil (14) when the excitation coil (14) is energized; and move the movable element (13) from a non-excitation location to an excitation location. The contact device (1, 1e, 1f) includes a fixed contact (311, 321) and a movable contact (81, 82). The contact device (1, 1e, 1f) is configured to switch between a closed state where the movable contact (81, 82) is in contact with the fixed contact (311, 321) and an open state where the movable contact (81, 82) is apart from the fixed contact (311, 321) as the movable element (13) moves. The bus bar (21, 22, 21a, 22a, 22b, 21c, 22c, 22e, 22f, 21g, 22g, 22h, 22i, 103 to 106) is electrically connected to the fixed contact (311, 321). The magnetic field generated by a current flowing through the bus bar (21, 22, 21a, 22a, 22b, 21c, 22c, 22e, 22f, 21g, 22g, 22h, 22i, 103 to 106) when the contact device (1, 1e, 1f) is in the closed state applies, to the movable element(13), force oriented such that the movable element (13) is maintained at a location where the contact device (1, 1e, 1f) is in the closed state. In such a positional relationship, the bus bar (21, 22, 21a, 22a, 22b, 21c, 22c, 22e, 22f, 21g, 22g, 22h, 22i, 103 to 106) and the electromagnetic device (10) are disposed.

With this aspect, the current flowing through the bus bar (21, 22, 21a, 22a, 22b, 21c, 22c, 22e, 22f, 21g, 22g, 22h, 22i, 103 to 106) applies, to maintain movable element(13), force oriented such that the movable element (13) is maintained at a location where the contact device (1, 1e, 1f) is in the closed state. This can improve the force that maintains the movable element (13) at the location where the contact device (1, 1e, 1f) is in the closed state.

In an electromagnetic relay (100, 100e, 100f, 100g, 100h, 100i) of a second aspect referring to the first aspect, the bus bar (21, 22, 21a, 22a, 22b, 21c, 22c, 22e, 22f, 21g, 22g, 22h, 22i, 103 to 106) includes an electrical path segment (225, 225a to 225i, 226e, 226f). The electrical path segment (225, 225a to 225i, 226e, 226f) extends along a tangent line direction (D1) of part (141) of the excitation coil (14) in a circumferential direction of the excitation coil (14) when viewed from one side in an axial direction of the excitation coil (14). An orientation of a current flowing through the electrical path segment (225, 225a to 225i, 226e, 2260 is a same as an orientation of a current flowing through the part (141) of the excitation coil (14) in the circumferential direction of the excitation coil (14) when the excitation coil (14) is energized.

With this aspect, the current flowing through the electrical path segment (225, 225a to 225i, 226e, 226f) can assist with force acting from the excitation coil (14) to the movable element (13).

An electromagnetic relay (100, 100e, 100f, 100g, 100h, 100i) of a third aspect includes: an electromagnetic device (10), a fixed terminal (31, 32), a movable contactor (8), and a bus bar (21, 22, 21a, 22a, 22b, 21c, 22c, 22e, 22f, 21g, 22g, 22h, 22i, 103 to 106). The electromagnetic device (10) includes an excitation coil (14), a stator (12), a movable element (13), and a yoke (11). The yoke (11) serves as part of a path of a magnetic flux generated at the excitation coil (14). The electromagnetic device (10) is configured to: attract the movable element (13) to the stator (12) by a magnetic field generated at the excitation coil (14) when the excitation coil (14) is energized; and move the movable element (13) from a non-excitation location to an excitation location. The fixed terminal (31, 32) includes a fixed contact (311, 321). The movable contactor (8) includes a movable contact (81, 82). The bus bar (21, 22, 21a, 22a, 22b, 21c, 22c, 22e, 22f, 21g, 22g, 22h, 22i, 103 to 106) is electrically connected to the fixed contact (311, 321). The yoke (11) includes a yoke upper board (111) located on a same side as the movable contactor (8) with respect to the excitation coil (14). At least part of the bus bar (21, 22, 21a, 22a, 22b, 21c, 22c, 22e, 22f, 21g, 22g, 22h, 22i, 103 to 106) is disposed at a location where the at least part of the bus bar overlaps the yoke upper board (111) or a location on an opposite side of the yoke upper board (111) from the movable contactor (8) when viewed in a direction orthogonal to an axial direction of the excitation coil (14). The bus bar (21, 22, 21a, 22a, 22b, 21c, 22c, 22e, 22f, 21g, 22g, 22h, 22i, 103 to 106) includes an electrical path segment (225, 225a to 225i, 226e, 2260. The electrical path segment (225, 225a to 225i, 226e, 2260 extends along a tangent line direction (D1) of part (141) of the excitation coil (14) in a circumferential direction of the excitation coil (14) when viewed from one side in the axial direction of the excitation coil (14). An orientation of a current flowing through the electrical path segment (225, 225a to 225i, 226e, 2260 is a same as an orientation of a current flowing through the part (141) of the excitation coil (14) in the circumferential direction of the excitation coil (14) when the excitation coil (14) is energized.

With this aspect, the current flowing through the bus bar (21, 22, 21a, 22a, 22b, 21c, 22c, 22e, 22f, 21g, 22g, 22h, 22i, 103 to 106) applies, to the movable contactor (8), force oriented such that the movable contactor (8) is maintained at a location where the contact device (1, 1e, 1f) is in the closed state. This can improve the force that maintains the movable contactor (8) at the location where the contact device (1, 1e, 1f) is in the closed state.

In an electromagnetic relay (100, 100e, 100f, 100g, 100h, 100i) of a fourth aspect referring to the second or third aspect, the electrical path segment (225, 225a to 225i, 226e, 2260 extends in a direction orthogonal to a travel direction of the movable element (13).

With this aspect, the current flowing through the electrical path segment (225, 225a to 225i, 226e, 2260 can efficiently assist with force acting from the excitation coil (14) to the movable element (13).

In an electromagnetic relay (100, 100e, 100f, 100g, 100h, 100i) of a fifth aspect referring to any one of the first to fourth aspects, the contact device (1, 1e, 1f) is in the open state when the movable element (13) is located at a non-excitation location. the contact device (1, 1e, 1f) is in the closed state when the movable element (13) is located at an excitation location. The magnetic field generated by the current flowing through the bus bar (21, 22, 21a, 22a, 22b, 21c, 22c, 22e, 22f, 21g, 22g, 22h, 22i, 103 to 106) when the contact device(1, 1e, 1f) is in the closed state applies, to the movable element(13), force oriented such that the movable element (13) is maintained at the excitation location.

With this aspect, in the electromagnetic relay (100, 100e, 100f, 100g, 100h, 100i), which is a normally-off electromagnetic relay, force to maintain the movable element (13) at the location when the contact device (1, 1e, 1f) is closed state can be improved.

In an electromagnetic relay (100, 100e, 100f, 100g, 100h, 100i) of a sixth aspect referring to any one of the first to fifth aspects, at least a part of the bus bar (21, 22, 21a, 22a, 22b, 21c, 22c, 22e, 22f, 21g, 22g, 22h, 22i, 103 to 106) is located between both ends of the excitation coil (14) in a travel direction of the movable element (13).

With this aspect, the current flowing through the electrical path segment (21, 22, 21a, 22a, 22b, 21c, 22c, 22e, 22f, 21g, 22g, 22h, 22i, 103 to 106) can efficiently assist with force acting from the excitation coil (14) to the movable element (13).

In an electromagnetic relay (100, 100e, 100f, 100g, 100h, 100i) of a seventh aspect referring to any one of the first to sixth aspects, the electromagnetic device (10) further includes a yoke (11) serving as part of a path of a magnetic flux generated at the excitation coil (14). At least part of the bus bar (21, 22, 21a, 22a, 22b, 21c, 22c, 22e, 22f, 21g, 22g, 22h, 22i, 103 to 106) is located between the yoke (11) and the excitation coil (14).

With this aspect, the bus bar (21, 22, 21a, 22a, 22b, 21c, 22c, 22e, 22f, 21g, 22g, 22h, 22i, 103 to 106) is disposed at a location closer to the excitation coil (14) than it is disposed in the outer side of the yoke (11). This makes it possible to further increase force applied to the movable element (13) from the bus bar (21, 22, 21a, 22a, 22b, 21c, 22c, 22e, 22f, 21g, 22g, 22h, 22i, 103 to 106).

In an electromagnetic relay (100, 100e, 100f, 100g, 100h, 100i) of an eighth aspect referring to the third aspect, the fixed contact (311, 321) is provided on one end side of the fixed terminal (31, 32). The bus bar (21, 22, 21a, 22a, 22b, 21c, 22c, 22e, 22f, 21g, 22g, 22h, 22i, 103 to 106) is fixed on the other end side of the fixed terminal (31, 32).

This aspect enables the bus bar (21, 22, 21a, 22a, 22b, 21c, 22c, 22e, 22f, 21g, 22g, 22h, 22i, 103 to 106) to be fixed to a predetermined location.

In an electromagnetic relay (100, 100e, 100f, 100g, 100h, 100i) of a ninth aspect referring to the third aspect, the bus bar (21, 22, 21a, 22a, 22b, 21c, 22c, 22e, 22f, 21g, 22g, 22h, 22i, 103 to 106) includes an upper electrical path segment (213, 223) through which a current flows in a same orientation as or in an opposite orientation to an orientation in which a current flows through the movable contactor (8). The upper electrical path segment (213, 223) is located on a same side as the movable contactor (8) with respect to the excitation coil (14).

This configuration enables force to be applied from the bus bar (21, 22, 21a, 22a, 22b, 21c, 22c, 22e, 22f, 21g, 22g, 22h, 22i, 103 to 106) to the movable contactor (8).

In an electromagnetic relay (100, 100e, 100f, 100g, 100h, 100i) of a tenth aspect referring to any one of the first to ninth aspects, the movable element (13) is disposed on an inner side of the excitation coil (14).

This aspect enables the magnetic flux generated at the excitation coil (14) to be efficiently applied to the movable element (13).

The electric apparatus (M1, M1a) according to an eleventh aspect includes: the electromagnetic relay (100, 100e, 100f, 100g, 100h, 100i) of any one of the first to tenth aspects; and a housing (M3, M3a) that holds the electromagnetic relay (100, 100e, 100f, 100g, 100h, 100i).

With this aspect, the current flowing through the bus bar (21, 22, 21a, 22a, 22b, 21c, 22c, 22e, 22f, 21g, 22g, 22h, 22i, 103 to 106) applies, to maintain movable element(13), force oriented such that the movable element (13) is maintained at a location where the contact device (1, 1e, 1f) is in the closed state. This can improve the force that maintains the movable element (13) at the location where the contact device (1, 1e, 1f) is in the closed state.

The electric apparatus (M1, M1a) according to a twelfth aspect includes: an electromagnetic relay (100, 100e, 100f, 100g, 100h, 100i); a housing (M3, M3a) that holds the electromagnetic relay (100, 100e, 100f, 100g, 100h, 100i); and a conductive bar (M21, M22, M21a, M22a) held by the housing (M3, M3a). The electromagnetic relay (100, 100e, 100f, 100g, 100h, 100i) includes an electromagnetic device (10) and a contact device (1, 1e, 1f). The electromagnetic device (10) includes an excitation coil (14), a stator (12), and a movable element (13) and is configured to attract the movable element (13) to the stator (12) by a magnetic field generated at the excitation coil (14) when the excitation coil (14) is energized and move the movable element (13) from a non-excitation location to an excitation location. The contact device (1, 1e, 1f) includes a fixed contact (311, 321) and a movable contact (81, 82). The contact device (1, 1e, 1f) is configured to switch between a closed state where the movable contact (81, 82) is in contact with the fixed contact (311, 321) and an open state where the movable contact (81, 82) is apart from the fixed contact (311, 321) as the movable element (13) moves. a magnetic field generated by a current flowing through the conductive bar (M21, M22, M21a, M22a) when the contact device (1, 1e, 1f) is in the closed state applies, to the movable element (13), force oriented such that the movable element (13) is maintained at a location where the contact device (1, 1e, 1f) is in the closed state. In such a positional relationship, the conductive bar (M21, M22, M21a, M22a) and the electromagnetic device (10) are disposed.

With this aspect, a current flowing through the conductive bar (M21, M22, M21a, M22a) applies, to the movable element(13), force oriented such that the movable element (13) is maintained at a location where the contact device (1, 1e, 1f) is in the closed state. This can improve the force that maintains the movable element (13) at the location where the contact device (1, 1e, 1f) is in the closed state.

In an electric apparatus (M1, M1a) of a thirteenth aspect referring to the twelfth aspect, the conductive bar (M21, M22, M21a, M22a) includes an electrical path segment (M225, M225a). The electrical path segment (M225, M225a) extends along a tangent line direction (D1) of part (141) of the excitation coil (14) in a circumferential direction of the excitation coil (14) when viewed from one side in an axial direction of the excitation coil (14). An orientation of a current flowing through the electrical path segment (M225, M225a) is a same as an orientation of a current flowing through the part (141) of the excitation coil (14) in the circumferential direction of the excitation coil (14) when the excitation coil (14) is energized.

With this aspect, the current flowing through the electrical path segment (M225, M225a) can assist with force acting from the excitation coil (14) to the movable element (13).

In an electric apparatus (M1, M1a) of a fourteenth aspect referring to the thirteenth aspect, the electrical path segment (M225, M225a) extends in a direction orthogonal to a travel direction of the movable element (13).

With this aspect, the current flowing through the electrical path segment (M225, M225a) can efficiently assist with force acting from the excitation coil (14) to the movable element (13).

An electric apparatus (M1, M1a) of a fifteenth aspect referring to any one of the twelfth to fourteenth aspects, the contact device (1, 1e, 1f) is in the open state when the movable element (13) is located at the non-excitation location. The contact device (1, 1e, 1f) is in the closed state when the movable element (13) is located at the excitation location. The magnetic field generated by the current flowing through the conductive bar (M21, M22, M21a, M22a) when the contact device (1, 1e, 1f) is in the closed state applies, to the movable element(13), force oriented such that the movable element (13) is maintained at the excitation location.

With this aspect, in the electromagnetic relay (100, 100e, 100f, 100g, 100h, 100i), which is a normally-off electromagnetic relay, force to maintain the movable element (13) at the location when the contact device (1, 1e, 1f) is closed state can be improved.

An electric apparatus (M1, M1a) of a sixteenth aspect referring to any one of the twelfth to fifteenth aspects, at least part of the conductive bar (M21, M22, M21a, M22a) is located between both ends of the excitation coil (14) in a travel direction of the movable element (13).

With this aspect, the current flowing through the conductive bar (M21, M22, M21a, M22a) can efficiently assist with force acting from the excitation coil (14) to the movable element (13).

An electric apparatus (M1, M1a) of a seventeenth aspect referring to any one of the twelfth to sixteenth aspects further includes a connector provided to the housing (M3, M3a). in a state where the electromagnetic relay (100, 100e, 100f, 100g, 100h, 100i) is held by the housing (M3, M3a), the fixed contact (311, 321) is electrically connected to the conductive bar (M21, M22, M21a, M22a) via the connector.

This aspect facilitates operation of connecting the electromagnetic relay (100, 100e, 100f, 100g, 100h, 100i) to the conductive bar (M21, M22, M21a, M22a).

In an electric apparatus (M1, M1a) of an eighteenth aspect referring to any one of the twelfth to seventeenth aspects, the conductive bar (M21, M22, M21a, M22a) is electrically connected to the fixed contact (311, 321).

With this aspect, when a current flows to the fixed contact (311, 321), the current also flows to the conductive bar (M21, M22, M21a, M22a).

The configurations of the second to tenth aspects are not essential for the electromagnetic relay (100, 100e, 100f, 100g, 100h, 100i) and may thus be accordingly omitted.

The configurations of the thirteenth to eighteenth aspects are not essential for the electric apparatus (M1, M1a) and may thus be accordingly omitted.

A bus bar (21, 22, 21a, 22a, 22b, 21c, 22c, 22e, 22f, 21g, 22g, 22h, 22i, 103 to 106) according to a nineteenth aspect is included in the electromagnetic relay (100, 100e, 100f, 100g, 100h, 100i) of any one of the first to tenth aspects.

With this aspect, the current flowing through the bus bar (21, 22, 21a, 22a, 22b, 21c, 22c, 22e, 22f, 21g, 22g, 22h, 22i, 103 to 106) applies, to maintain movable element(13), force oriented such that the movable element (13) is maintained at a location where the contact device (1, 1e, 1f) is in the closed state. This can improve the force that maintains the movable element (13) at the location where the contact device (1, 1e, 1f) is in the closed state.

An electric apparatus (M1, M1a) of a twentieth aspect referring to any one of the eleventh to eighteenth aspects includes a plurality of electromagnetic relays (100, 100e, 100f, 100g, 100h, 100i). The plurality of electromagnetic relays (100, 100e, 100f, 100g, 100h, 100i) include a first electromagnetic relay (101) and a second electromagnetic relay (102). A magnetic field generated by a current flowing through the conductive bar (M21, M22, M21a, M22a) when contact devices (1, 1e, 1f) of both the first electromagnetic relay (101) and the second electromagnetic relay (102) are in the closed state applies, to movable elements (13) of both the first magnetic relay and the second magnetic really, force oriented such that the movable elements (13) of both the first electromagnetic relay (101) and the second electromagnetic relay (102) are maintained at locations where the contact devices (1, 1e, 1f) are in a closed state. In such a positional relationship, the conductive bar (M21, M22, M21a, M22a) and electromagnetic devices (10) of both the first electromagnetic relay (101) and the second electromagnetic relay (102) are disposed.

With this aspect, it is possible to improve the force that maintains the movable elements (13) at the locations where the contact devices (1, 1e, 1f) are in the closed state in both the first electromagnetic relay (101) and the second electromagnetic relay (102).

An electric apparatus case (M10, M10a) of a twenty-first aspect includes the housing (M3, M3a) of the electric apparatus (M1, M1a) of any one of the eleventh to eighteenth aspects, and a conductive bar (M21, M22, M21a, M22a).

With this aspect, a current flowing through the conductive bar (M21, M22, M21a, M22a) applies, to the movable element(13), force oriented such that the movable element (13) is maintained at a location where the contact device (1, 1e, 1f) is in the closed state. This can improve the force that maintains the movable element (13) at the location where the contact device (1, 1e, 1f) is in the closed state.

### REFERENCE SIGNS LIST

1 1e, if CONTACT DEVICE
10 ELECTROMAGNETIC DEVICE
12 STATOR
13 MOVABLE ELEMENT
14 EXCITATION COIL
21, 22, 21a, 22a, 22b, 21c, 22c, 22e, 22f, 21g, 22g, 22h, 22i, 103 to 106 BUS BAR
81, 82 MOVABLE CONTACT
100, 100e, 100f, 100g, 100h, 100i ELECTROMAGNETIC RELAY
101 FIRST ELECTROMAGNETIC RELAY
102 SECOND ELECTROMAGNETIC RELAY
141 PART IN CIRCUMFERENTIAL DIRECTION (OF EXCITATION COIL)
225, 225a to 225i, 226e, 226f ELECTRICAL PATH SEGMENT
311, 321 FIXED CONTACT
D1 TANGENT LINE DIRECTION
M3, M3a HOUSING
M21, M22, M21a, M22a CONDUCTIVE BAR
M225, M225a ELECTRICAL PATH SEGMENT

1. An electromagnetic relay, comprising:
an electromagnetic device
including an excitation coil, a stator, and a movable element and configured to
attract the movable element to the stator by a magnetic field generated at the excitation coil when the excitation coil is energized and
move the movable element from a non-excitation location to an excitation location;
a contact device
including a fixed contact and a movable contact and
configured to switch between a closed state where the movable contact is in contact with the fixed contact and an open state where the movable contact is apart from the fixed contact as the movable element moves; and
a bus bar electrically connected to the fixed contact,
the bus bar and the electromagnetic device being disposed in such a positional relationship that the magnetic field generated by a current flowing through the bus bar when the contact device is in the closed state applies, to the movable element, force oriented such that the movable element is maintained at a location where the contact device is in the closed state.

2. The electromagnetic relay of claim 1, wherein
the bus bar includes an electrical path segment extending along a tangent line direction of part of the excitation coil in a circumferential direction of the excitation coil when viewed from one side in an axial direction of the excitation coil, and
an orientation of a current flowing through the electrical path segment is a same as an orientation of a current flowing through the part of the excitation coil in the circumferential direction of the excitation coil when the excitation coil is energized.

3. An electromagnetic relay, comprising:
an electromagnetic device
including an excitation coil, a stator, a movable element, and a yoke serving as part of a path of a magnetic flux generated at the excitation coil and
configured to
attract the movable element to the stator by a magnetic field generated at the excitation coil when the excitation coil is energized and
move the movable element from a non-excitation location to an excitation location;
a fixed terminal including a fixed contact;
a movable contactor including a movable contact; and
a bus bar electrically connected to the fixed contact,
the yoke including a yoke upper board located on a same side as the movable contactor with respect to the excitation coil,
at least part of the bus bar being disposed at a location where the at least part of the bus bar overlaps the yoke upper board or at a location on an opposite side of the yoke upper board from the movable contactor when viewed in a direction orthogonal to an axial direction of the excitation coil,
the bus bar including an electrical path segment extending along a tangent line direction of part of the excitation coil in a circumferential direction of the excitation coil when viewed from one side in the axial direction of the excitation coil,
an orientation of a current flowing through the electrical path segment is a same as an orientation of a current flowing through the part of the excitation coil in the circumferential direction of the excitation coil when the excitation coil is energized.

4. The electromagnetic relay of claim 2, wherein
the electrical path segment extends in a direction orthogonal to a travel direction of the movable element.

5. The electromagnetic relay of claim 1, wherein
the contact device is in the open state when the movable element is located at a non-excitation location,
the contact device is in the closed state when the movable element is located at an excitation location,
the magnetic field generated by the current flowing through the bus bar when the contact device is in the closed state applies, to the movable element, force oriented such that the movable element is maintained at the excitation location.

6. The electromagnetic relay of claim 1, wherein
at least a part of the bus bar is located between both ends of the excitation coil in a travel direction of the movable element.

7. The electromagnetic relay of claim 1, wherein
the electromagnetic device further includes a yoke serving as part of a path of a magnetic flux generated at the excitation coil, and
at least part of the bus bar is located between the yoke and the excitation coil.

8. The electromagnetic relay of claim 3, wherein
the fixed contact is provided on one end side of the fixed terminal, and
the bus bar is fixed on the other end side of the fixed terminal.

9. The electromagnetic relay of claim 3, wherein
the bus bar includes an upper electrical path segment through which a current flows in a same orientation as or in an opposite orientation to an orientation in which a current flows through the movable contactor, and
the upper electrical path segment is located on a same side as the movable contactor with respect to the excitation coil.

10. The electromagnetic relay of claim 1, wherein
the movable element is disposed on an inner side of the excitation coil.

11. The electric apparatus, comprising:
the electromagnetic relay of claim 1; and
a housing that holds the electromagnetic relay.

12. An electric apparatus, comprising:
an electromagnetic relay,
a housing that holds the electromagnetic relay, and
a conductive bar held by the housing,
the electromagnetic relay including
an electromagnetic device
including an excitation coil, a stator, and a movable element and configured to
attract the movable element to the stator by a magnetic field generated at the excitation coil when the excitation coil is energized and
move the movable element from a non-excitation location to an excitation location; and
a contact device
including a fixed contact and a movable contact and
configured to switch between a closed state where the movable contact is in contact with the fixed contact and an open state where the movable contact is apart from the fixed contact as the movable element moves; and
the conductive bar and the electromagnetic device being disposed in such a positional relationship that the magnetic field generated by a current flowing through the conductive bar when the contact device is in the closed state applies, to the movable element, force oriented such that the movable element is maintained at a location where the contact device is in the closed state.

13. The electric apparatus of claim 12, wherein
the conductive bar includes an electrical path segment extending along a tangent line direction of part of the excitation coil in a circumferential direction of the excitation coil when viewed from one side in an axial direction of the excitation coil, and
an orientation of a current flowing through the electrical path segment is a same as an orientation of a current flowing through the part of the excitation coil in the circumferential direction of the excitation coil when the excitation coil is energized.

14. The electric apparatus of claim 13, wherein
the electrical path segment extends in a direction orthogonal to a travel direction of the movable element.

15. The electric apparatus of claim 12, wherein
the contact device is in the open state when the movable element is located at the non-excitation location,
the contact device is in the closed state when the movable element is located at the excitation location,
the magnetic field generated by the current flowing through the conductive bar when the contact device is in the closed state applies, to the movable element, force oriented such that the movable element is maintained at the excitation location.

16. The electric apparatus of claim 12, wherein
at least part of the conductive bar is located between both ends of the excitation coil in a travel direction of the movable element.

17. The electric apparatus of claim 12, further comprising a connector provided to the housing, wherein
in a state where the electromagnetic relay is held by the housing, the fixed contact is electrically connected to the conductive bar via the connector.

18. The electric apparatus of claim 12, wherein
the conductive bar is electrically connected to the fixed contact.
